(19) United States
(12) Patent Application Publication
(10) Pub. No.: US 2008/0162031 A1
(43) Pub. Date: Jul. 3, 2008

(54) INFORMATION PROCESSING APPARATUS, INFORMATION PROCESSING METHOD AND INFORMATION PROCESSING PROGRAM

(75) Inventors: Kyouko OKUYAMA, Kawasaki (JP); Toshiyuki FUKUOKA, Kawasaki (JP); Eiji KITAGAWA, Kawasaki (JP); Takuro IKEDA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/862,692

(22) Filed: Sep. 27, 2007

(30) Foreign Application Priority Data
Dec. 28, 2006 (JP) 2006-356543

(51) Int. Cl. G01C 21/00; G06F 17/30

(52) U.S. Cl. 701/200

(57) ABSTRACT

An information processing apparatus that is connected to a map recording part, a display and an input apparatus includes: a display controlling part that allows the display to display a map and a point mark; an information detailing part that generates a displaying form data of a plurality of point marks that are integrated by an integrated point mark, and calculating a scale and a displaying range, in the case where an operation by a user for demanding information detailing is detected; an information integrating part that generates displaying form data of the integrated point mark that integrates to represent point information of a plurality of points, and calculating a scale and a displaying range, in the case where an operation by the user for demanding information integration is detected. Thereby, the information processing apparatus can secure the visibility of the map, and can enhance the easiness of the operations of obtaining the point information such as facility information, traffic information and reputational information on the map.

### BACKGROUND OF THE INVENTION

1. Field of the Invention

The present invention relates to an information processing apparatus that displays point information (POI (Point of Interest) information) including facility information, traffic information, reputational information and the like, for example, on a map that is displayed by a computer, a map that is displayed by a navigation apparatus or the like, a information processing method and an information processing program.

2. Description of Related Art

Conventionally, for example, in a car navigation apparatus, facility information (a kind of the POI information) including gas stations, convenience stores, banks, supermarkets, stations and public utilities is displayed as landmarks being overlapped on a road map. Thus, in a case of a densely built area such as an urban area, landmarks showing the facility information may be overlapped so as to hide the landmarks themselves or the road map depending on a scale of the map, and visibility of the map is degraded. Then, in order to solve such a problem, for example, a method of switching the landmarks to be displayed, and reducing kinds of the landmarks to be displayed as the scale is smaller is suggested (see, for example, JP 2006-155603 A). Moreover, a method of displaying the plurality of the overlapped landmarks as one multiple icon collectively, and displaying the plurality of the original landmarks when selecting and operating the multiple icon is suggested (see, for example, JP 2002-340588 A). Moreover, a method of dividing the display screen into a plurality of partitions, and displaying a plurality of landmarks that is included in the partition by substituting them with a representative landmark is also suggested (see, for example, JP 2004-69561 A). Moreover, a method of collecting landmarks into a landmark having a genre that is in one or more higher hierarchy according to a displaying zoom rate, and displaying them not as the landmarks but as dots at a smaller displaying zoom rate is also suggested (see, for example, JP 2002-372427 A).

However, in the conventional methods described above, the viewability (visibility) of the map is improved, but when the scale of the map is changed, a landmark of facility information to which the user pays attention is disappeared, and a correspondence relationship of positions of the landmark before and after the change of the scale is unclear. Thus, since the user is required to check a detailed position of the facility or the like on the map by changing the scale manually in one-by-one step, it takes an effort and time to reach the map display that can attain the original object, thereby degrading the easiness of the operation for obtaining the point information.

### SUMMARY OF THE INVENTION

Therefore, it is an object of the present invention to provide an information processing apparatus that can secure visibility of a map, and enhance easiness of an operation for obtaining point information such as facility information, traffic information, reputational information and the like on the map, an information processing method and an information processing program.

The information processing apparatus of the present invention is an information processing apparatus that is connected to a map recording part in which map information and point information on a predetermined point shown by the map information is recorded, a display and an input apparatus, the information processing apparatus including: a display controlling part that allows the display to display: a map; and a point mark including at least one of an integrated point mark that integrates point information of a plurality of points and is represented by one mark and a single point mark that represents point information of one point, based on the map information and the point information that are recorded in the map recording part; an information detailing part that, in a case where an operation by a user for demanding information detailing of the integrated point mark that is displayed on the display is detected via the input apparatus, generates displaying form data of a plurality of the point marks that represent point information of the plurality of the points integrated by the integrated point mark, calculates a scale and a displaying range that enable to display the plurality of the point marks, and allows the display to display the plurality of the point marks represented by the displaying form data and the map with the scale and the displaying range; and an information integrating part that, in a case where an operation by the user for demanding information integration of the point marks that are displayed on the display is detected via the input apparatus, generates displaying form data of the integrated point mark that represents by integrating point information of a plurality of points including points of the point marks, calculates a scale and a displaying range that enable to display the integrated point mark in a wider range than a range at the time of the operation by the user, and allows the display to display the integrated point mark represented by the displaying form data and the map with the scale and the displaying range.

According to the configuration described above, in the case where the user performs an operation for demanding information detailing of the integrated point mark that is displayed on the display via the input apparatus, the information detailing part generates the displaying form data of the plurality of the point marks showing the point information of the plurality of the points that are integrated into the integrated point mark, and calculates the scale and the displaying range that allows to display the plurality of the point marks. And, the plurality of the point marks that are shown by the displaying form data and the map with the scale and the displaying range are displayed on the display. Thus, the integrated point mark that is demanded to be detailed by the user is detailed, which is displayed as the plurality of the point marks, and the map with the scale and the displaying range that are appropriate for this detailing is displayed on the display.

Moreover, in the case where the user performs an operation for demanding the information integration of the point marks that are displayed on the display via the input apparatus, the information integrating part generates the displaying form data of the integrated point mark that integrates and shows the point information of the plurality of the points including the point shown by the point mark, and calculates the scale and the displaying range that can display the integrated point mark in a wider area than that at the time when the user performs the operation. Incidentally, the point mark to be demanded for integration by the user may be both of the integration point mark and the single point mark, or either of them. The information integrating part allows the display to display the integrated point mark represented by the generated displaying form data and the map with the calculated scale and displaying range. Thus, in addition to the integrated point mark representatively showing the point information around the point mark that is demanded for integration by the user, the map with a wider range than that at the time of the operation is displayed with an appropriate scale on the display.

By the processing, the scale and the displaying range of the map are adjusted automatically, depending on the detailing step and the integrating step of the information according to the operation by the user. As a result, the disappearance of the point mark that has been displayed, which is caused by the change of the scale, can be prevented, and the positional relationship of the point mark that is displayed before and after the change of the scale is prevented from being unclear. Thus, in the case where the user checks a detailed position of a facility or the like on the map, and in the case where the map in a wider region including the facility or the like on the map is displayed, a time required for displaying the aimed information is shorter than that in with the case of changing the scale manually in one-by-one step. As a result, the easiness for the user to operate the point information can be enhanced.

It should be noted that the point information includes facility information that is in a position specified by the map, traffic information at the position, reputational information at the position, and other information relating to the position in which the user may be interested. The position that is specified on the map is not necessarily shown by a dot, but may be a place having a certain area.

Moreover, a mark showing point information or a location of the point information on the map is denoted as a point mark. Examples of the point mark include: a mark showing a facility such as a gas station, a convenience store, a bank, a supermarket, a station and a public utility; a mark showing a spot such as a hot spring, a beach, a scenic spot and a historic spot; a mark showing word-of-mouth information on the facility and the spot; a mark showing traffic information such as a traffic jam, a road work and a road sign; a navigation mark showing destination, a present position or the like; a mark showing weather information; and the like. Moreover, the point mark includes an integrated point mark that shows point information of a plurality of points representatively by one mark, and a single point mark that shows point information of one point.

In the information processing apparatus of the present invention, it is preferable that the information detailing part calculates the scale and the displaying range that enables to display, in one screen, all of the plurality of the point marks that represent a plurality of sets of the point information integrated by the integrated point mark. Thereby, all of integrated marks that are demanded for detailing by the user can be displayed being detailed on one screen, and the detailed information that is demanded by the user can be displayed with more visibility.

In the information processing apparatus of the present invention, it is preferable that the information integrating part calculates the scale and the displaying range such that the integrated point mark represented by the displaying form data is displayed at the same position as a position where the point mark that is demanded for the integration by the user is displayed at the time of the operation by the user. Thereby, the point marks that are demanded for integration by the user are integrated at the same position as the position where the point marks are displayed at the time of the operation of this demand, and the map is displayed in a wider range than that at the time of the operation. As a result, it becomes more easier for the user to recognize the correspondence relationship between the point marks before the integration and the integrated point mark after the integration.

In the information processing apparatus of the present invention, it is preferable that the information detailing part calculates the scale and the displaying range to an extent that the plurality of the point marks representing the plurality of the sets of the point information that are integrated by the integrated point mark can be displayed without being overlapped with one another, and the information integrating part calculates the scale and the displaying range to an extent that the point marks which respectively represent the point information of the plurality of the points in a predetermined range from a point corresponding to the point mark are displayed being overlapped with each other.

According to the configuration described above, the point marks, which are displayed after the detailing or the integration of the information according to the operation by the user, are displayed with the scale and the displaying range that are calculated so as not to overlap the point marks with one another. Thus, the map and the point marks that are more visible for the user are displayed.

The information processing apparatus of the present invention may include: a partition setting part that generates partition information on each partition in a case of dividing the map that is displayed with the scale and the displaying range into a plurality of partitions, based on the scale and the displaying range of the map recorded in a map attribution recording part; and a mark calculating part that obtains the point information in the partition, each of which is represented by the partition information generated by the partition setting part, from the map recording part, and generates the displaying form data of the point mark displayed in the partition based on the position information. And, it is preferable that the information detailing part calculates the scale and the displaying range based on the point information included in the partition, in which the integrated point mark is present, among the partitions of the map that are displayed at the time of the operation by the user, allows the partition setting part to generate partition information related to each partition that is obtained by dividing the map displayed with the calculated scale and displaying range, and allows the mark calculating part to generate displaying form data of the point mark that is displayed in each partition represented by the partition information, and the information integrating part calculates a scale and a displaying range of a map after the integration such that the displaying range displayed at the time of the operation by the user corresponds to at least one partition in the map after the integration, allows the partition setting part to generate partition information on each partition that is obtained by dividing the map which is displayed with the calculated scale and displaying range, and allows the mark calculating part to generate displaying form data of the point mark that is displayed in each partition represented by the partition information.

The information detailing part calculates the scale and the displaying range based on the point information that is included in a partition in which the integrated point mark is present, among the partitions of the map that are displayed at the time of the operation by the user. The partition setting part generates the partition information regarding the plurality of the partitions that are obtained by dividing the map with such scale and displaying range. The mark recording part generates the displaying form data of the point mark that is displayed in the partition based on the point information included in the partition, with respect to each of the plurality of the partitions shown by the partition information. Thereby, the point information in the partition of the integrated point mark that is demanded for the detailing by the user is detailed, and is displayed with the map with an appropriate scale and displaying range. Moreover, in this displayed map, since the point mark is displayed in each of the plurality of the partitions, the integrated point mark that is demanded for the detailing by the user is displayed being detailed into a single point mark or a integrated point mark in each partition.

Moreover, the information integrating part calculates a scale and a displaying range of the map after the integration such that the displaying range displayed at the time of the operation by the user corresponds to at least one partition in the map after the integration. The partition setting part generates the partition information regarding the plurality of the partitions that are obtained by dividing the map with the calculated scale and displaying range, and the mark recording part generates the displaying form data of the point mark that is displayed in the partition based on the point information included in the partition, with respect to each of the plurality of the partitions. Thereby, the map, whose displaying range at the time when the user performs the integration demanding operation corresponds to at least one partition in the map after the integration, is displayed, and the integrated point mark or the single point mark is displayed in each of the partitions on this displayed map. Thus, the point mark that is displayed at the time of a designating operation by the user is displayed being integrated into a point mark in the corresponding partition in the map after the integration. As a result, the point mark is displayed being integrated with the appropriate scale and displaying range.

In the present invention, it is preferable that the information integrating part determines a size of an integrated point mark that representatively shows point information of a plurality of points that are present in a predetermined range from a point corresponding to the designated point mark, according to the number of the plurality of the points that are present in the predetermined range, and allows the displaying form data to include the size of the integrated point mark as a part.

Thereby, the integrated point mark with a size depending on the number of the plurality of the points that are represented by the integrated point mark is displayed. Thus, the user can immediately recognize how much information is integrated by viewing the integrated point mark.

The information processing program that is recorded in the recording medium of the present invention is an information processing program that allows a computer to execute processing, the computer being connected to a map recording part in which map information and point information on a predetermined point shown by the map information are recorded, a display and an input apparatus. The information processing program allows the computer to execute: display controlling processing of allowing the display to display: a map; and a point mark including at least one of an integrated point mark that integrates point information of a plurality of points and is represented by one mark, and a single point mark that represents point information of one point, based on the map information and the point information that are recorded in the map recording part; information detailing processing including, in a case where an operation by a user for demanding information detailing of the integrated point mark that is displayed on the display is detected via the input apparatus, generating displaying form data of a plurality of the point marks that represent point information of a plurality of points integrated by the integrated point mark, calculating a scale and a displaying range that enable to display the plurality of the point marks, and allowing the display to display the plurality of the point marks represented by the displaying form data and the map with the scale and the displaying range; and information integrating processing including, in a case where an operation by the user for demanding information integration of the point marks that are displayed on the display is detected via the input apparatus, generating displaying form data of the integrated point mark that represents by integrating point information of a plurality of points that are present in a predetermined range from the point that corresponds to the point mark, calculating a scale and a displaying range that enable to display the integrated point mark in a wider range than a range at the time of the operation by the user, and allowing the display to display the integrated point mark represented by the displaying form data and the map with the scale and the displaying range.

The information processing method of the present invention is an information processing method executed by a computer that is connected to a map recording part in which map information and point information on a predetermined point shown by the map information are recorded, a display and an input apparatus. The information processing method includes: a display controlling step allowing the display to display: a map; and a point mark including at least one of an integrated point mark that integrates point information of a plurality of points and is represented by one mark, and a single point mark that represents point information of one point, based on the map information and the point information that are recorded in the map recording part; an information detailing step including, in a case where an operation by a user for demanding information detailing of the integrated point mark that is displayed on the display is detected via the input apparatus, generating displaying form data of a plurality of the point marks that represent point information of a plurality of points integrated by the integrated point mark, calculating a scale and a displaying range that enable to display the plurality of the point marks, and allowing the display to display the plurality of the point marks represented by the displaying form data and the map with the scale and the displaying range; and an information integrating step including, in a case where an operation by the user for demanding information integration of the point marks that are displayed on the display is detected via the input apparatus, generating displaying form data of the integrated point mark that represents by integrating point information of a plurality of points that are present in a predetermined range from the point that corresponds to the point mark, calculating a scale and a displaying range that enable to display the integrated point mark in a wider range than a range at the time of the operation by the user, and allowing the display to display the integrated point mark represented by the displaying form data and the map with the scale and the displaying range.

The present invention can provide the information processing apparatus that can secure the visibility of the map, and enhance the easiness of the operation for obtaining point information such as facility information, traffic information and reputational information on the map, the information processing method and the information processing program.

These and other advantages of the present invention will become apparent to those skilled in the art upon reading and understanding the following detailed description with reference to the accompanying figures.

### BRIEF DESCRIPTION OF THE DRAWINGS

FIG. 1 is a functional block diagram showing a configuration of an information processing apparatus according to Embodiment 1.

FIG. 2 is a flow chart showing an operational example of an operation judging part according to Embodiment 1.

FIG. 3 is a flow chart showing a processing content of search processing.

FIG. 4 is a view showing an example of a quadrangle that represents a desired displaying range.

FIG. 5 is a view showing an example of a map and an icon.

FIG. 6 is a view for explaining a calculation example of a pixel coordinate.

FIG. 7 is a view showing an example of a relationship between the pixel coordinate and an icon displaying coordinate.

FIG. 8 is a view showing an example of a screen that is displayed by a display controlling part.

FIG. 9 is a flow chart showing a content of information detailing processing.

FIG. 10 is a flow chart showing a processing content of the information detailing processing.

FIG. 11 is a view for explaining a state of a map to be displayed on a display 3 at the time of detailing.

FIG. 12 is a functional block diagram showing a configuration of an information processing apparatus according to Embodiment 2.

FIG. 13 is a functional block diagram showing a detailed configuration of a displayed icon data forming part according to Embodiment 2.

FIG. 14 is a flow chart showing a processing content of search processing according to Embodiment 2.

FIG. 15A is a view showing an example of a maximum size of an icon, FIG. 15B is a view showing an example of a size of one partition that is set based on the maximum size of the icon of FIG. 15A.

FIG. 16 is a view showing an example of a partition that is set by a partition setting part.

FIG. 17 is a view showing a south-east coordinate and a north-west coordinate in one partition.

FIG. 18 is a view for explaining an example of a method for obtaining a displaying position of the icon by analyzing a distributional condition of facilities in a partition.

FIG. 19 is a view showing an example of a screen that is displayed by the display controlling part 15.

FIG. 20 is a flow chart showing a processing content of information detailing processing according to Embodiment 2.

FIG. 21 is a flow chart showing a processing content of information integrating processing according to Embodiment 2.

FIG. 22A is a view showing an example of a case where word-of-mouth icons are displayed being overlapped in multiplicity when displaying the map at a maximum scale, FIG. 22B is a view showing an example of a case where the word-of-mouth icons are displayed as an integrated icon.

FIG. 23A is a view showing an example of a map that is displayed with the word-of-mouth icons overlapped directly, FIG. 23B is a view showing an example of a map that is displayed by a function of an information processing apparatus 10.

FIGS. 24A and 24B are views showing an example of a case where icon designs are displayed variously depending on users.

FIG. 25 is a view showing an example where the icon designs are displayed variously depending on reputations.

### DESCRIPTION OF THE PREFERRED EMBODIMENTS

### Embodiment 1

### (Configuration of Information Processing Apparatus 1)

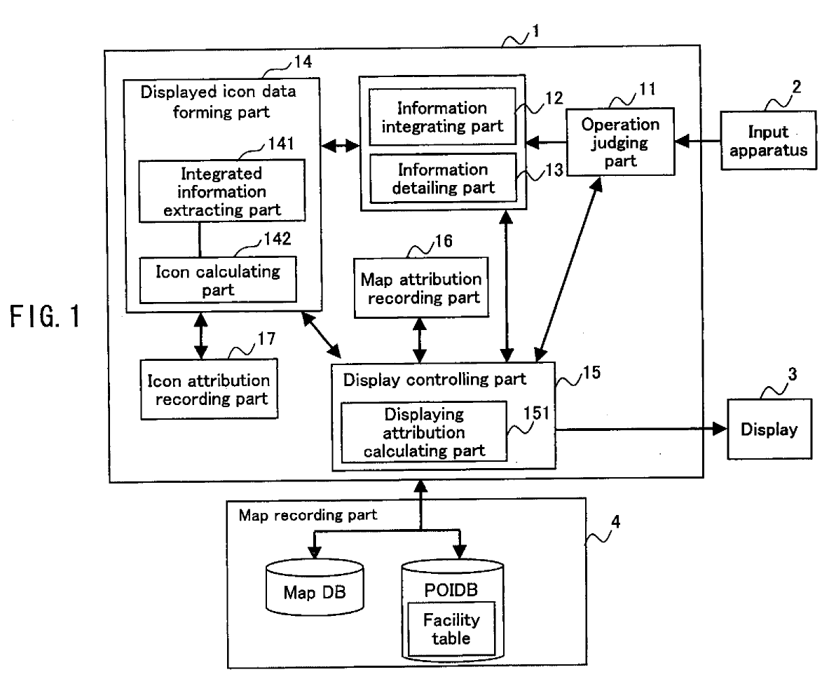

FIG. 1 is a functional block diagram showing a configuration of an information processing apparatus according to Embodiment 1. The information processing apparatus 1 shown in FIG. 1 is, for example, a car navigation apparatus in which a computer is loaded, and is connected to an input apparatus 2, a display 3 and a map recording part 4. The map recording part 4 includes a map DB for recording map information, and a POIDB for recording point information (POI information). The point information includes at least one of information on a facility at a predetermined position on the map or information on the predetermined position, which is represented by the map information. The information processing apparatus 1 reads out the map information and the point information recorded in the map recording part 4, based on an instruction that is input via the input apparatus 2 by the user, and allows the display 3 to display them. The display 3 displays the map and point marks showing the point information being overlapped. It should be noted that the explanation below will be provided by denoting the point information as POI information, and the point mark as an icon.

The map recording part 4 is achieved by a recording apparatus such as an optical recording apparatus, a magnetic recording apparatus and a semiconductor memory. The input apparatus 2 is, for example, a button, a remote controller, a microphone or the like, by which a user can input a signal for controlling the car navigation apparatus. The display 3 is, for example, a liquid crystal panel or the like. Incidentally it is also possible that the input apparatus 2 and the display 3 may be unified such as, for example, a touch panel.

The information processing apparatus of the present invention is not limited to a car navigation apparatus. The information processing apparatus of the present invention may be constituted of, for example, a computer that is incorporated in electronic equipment such as a mobile phone, a PDA and a portable game machine, or may be constituted of, for example, a general-purpose computer such as a personal computer. In the case of the general-purpose computer, for example, an input device such as a mouse and a key board is used as the input apparatus 2, and a CRT, a PDP, a LCD, a SED (Surface-conduction Electron-emitter Display) or the like may be used as the display 3.

The information processing apparatus 1 shown in FIG. 1 is provided with an operation judging part 11, an information integrating part 12, an information detailing part 13, a displayed icon data forming part 14, a display controlling part 15, a map attribution recording part 16 and an icon attribution recording part 17. Respective functions of the operation judging part 11, the information integrating part 12, the information detailing part 13, the displayed icon data forming part 14 and the display controlling part 15 are achieved by execution of a predetermined program by a calculating apparatus such as a CPU included in the computer. Thus, the program for achieving the respective functions described above by the computer, or a recording medium that records the program are also included in one embodiment of the present invention. Moreover, the map attribution recording part 16 and the icon attribution recording part 17 are realized by an internal memory in the computer or a memory that can be accessed from this computer. Incidentally, the map attribution recording part 16 and the icon attribution recording part 17 may record data temporarily, for example.

The map attribution recording part 16 records data that represents the attribution of the map to be displayed on the display 3. The attribution of the map includes a scale and a displaying range. The icon attribution recording part 17 records displaying form data of the icon to be displayed with the map on the display 3. The displaying form data includes, for example, a size of the icon (an icon size), a displaying position on a screen, a place of an icon image file and a data that represents if it is integrated or not. The icon is a mark that represents the POI information at a predetermined position on the map by, for example, a graphic form, a letter or the like. The icon includes at least an integrated icon that represents the POI information of a plurality of points representatively by one mark, and a single point icon that represents the POI information of one point.

The display controlling part 15 allows the display 3 to display the map and the icon based on: the scale and the displaying range of the map that is recorded in the map attribution recording part 16; the displaying form data of the icon that is recorded in the icon attribution recording part 17; and the map information and the POI information that is recorded in the map recording part 4. Moreover, the display controlling part 15 includes the display attribution calculating part 151.

The display attribution calculating part 151 receives data that represents a desired displaying range that is a range of the map desired to be displayed from the information integrating part 12 or the information detailing part 13, and calculates a scale and a displaying range that are appropriate for displaying the desired displaying range. Moreover, the displaying attribution calculating part 151 receives information on the scale and the icon that is designated by the user from the information integrating part 12 or the information detailing part 13, and calculates a displaying range such that the icon may be displayed near a center of the map. The scale and the displaying range that are calculated by the displaying attribution calculating part 151 are recorded in the map attribution recording part 16.

The operation judging part 11 detects the operation with respect to the navigation apparatus by using the input apparatus 2 by the user, and judges processing that is demanded by the user based on the detected operation. The operation judging part 11 allows the information integrating part 12, the information detailing part 13 or the display controlling part 15 to execute the processing that is judged to be demanded by the user.

The operation judging part 11 judges whether the operation by the user that is detected via the input apparatus 2 is an operation for demanding the information detailing of the integrated icon displayed on the display 3, or an operation for demanding the information integration of the single point icons or the integrated icons. If the operation judging part 11 judges that the designating operation of the icon by the user is the information detailing demanding operation, for example, the operation judging part 11 allows the information detailing part 13 to execute the information detailing processing of the designated icon. Moreover, if the operation judging part 11 judges that the designating operation of the icon by the user is the information integrating demanding operation, the operation judging part 11 allows the information integrating part 12 to execute the information integrating processing of the designated icon. It should be noted that the operation by the user for demanding the information detailing or the information integration is not limited to the case of including the designating operation of the icon. For example, the operation for designating a certain point on the map displayed on the display 3, a bottom or the like may be an operation for demanding the information detailing or the information integration.

The information detailing part 13 generates displaying form data of the plurality of the icons that are designated by the user and represent POI information of a plurality of points that are integrated by an integrated icon, records the displaying form data into the icon attribution recording part 17, calculates a scale and a displaying range that allows to display the plurality of the icons, and records them into the map attribution recording part 16. When calculating the scale and the displaying range, the information detailing part 13 can notify data representing the desired displaying range to the displaying attribution calculating part 151, and can instruct the calculation of the appropriate scale and displaying range. The information detailing part 13 records the data into the icon attribution recording part 17 and the map attribution recording part 16 as described above, and thereafter, instructs the display controlling part 15 to display the map based on the data.

Moreover, when generating the displaying form data, the information detailing part 13 notifies the scale and the displaying range of the map to the displayed icon data forming part 14, and instructs to form the displaying form data of the icon to be displayed with the scale and the displaying range. The displayed icon data forming part 14 refers the POIDB of the map recording part 4 so as to obtain the POI information on the plurality of the points integrated by the integrated icon that is designated by the user, and can use it for generating the displaying form data of the plurality of the icons representing the POI information.

The information integrating part 12 generates the displaying form data of the integrated icon that represents by integrating the POI information of the plurality of the points including the points that correspond to the icon designated by the user, records it into the icon attribution recording part 17, calculates a scale that allows to display the integrated icon in a wider displaying range than that at the time of the operation by the user and the displaying range, and records them into the map attribution recording part 16. The information integrating part 12 can notify the scale and the designated icon to the displaying attribution calculating part 151, and can instruct the calculation of the displaying range that allows to display the designated icon in the map with this scale. The information detailing part 3 thus records the data into the icon attribution recording part 17 and the map attribution recording part 16, and subsequently instructs the display controlling part 15 to display the map based on the data.

Moreover, when generating the displaying form data, the information integrating part 12 notifies the scale and the displaying range of the map to the displayed icon data forming part 14, and instructs to form the displaying form data of the icon to be displayed with the scale and the displaying range. The displayed icon data forming part 14 can refers the POIDB of the map recording part 4 so as to obtain POI information of plurality of points including the points that correspond to the icon designated by the user, and can generate the displaying form data of the integrated icon that represents by integrating the POI information.

The displayed icon data forming part 14 is provided with an integrated information extracting part 141 and an icon calculating part 142. The integrated information extracting part 141 receives the scale and the displaying range from the information integrating part 12 or the information detailing part 13, judges whether the icons that are displayed being overlapped are present or not in the scale and the displaying range, and extracts the icons that are displayed being overlapped. The icon calculating part 142 generates the appropriate displaying form data of the icons to be displayed with the scale and the displaying range based on the processing result of the integrated information extracting part 141, and records it into the icon attribution recording part 17. In particular, the icon calculating part 142 generates the displaying form data of the integrated icon integrating the icons that are judged to be displayed being overlapped.

It should be noted that the operation to be judged by the operation judging part 11 is not limited to the information detailing demanding operation and the information integrating demanding operation described above. For example, the operation judging part 11 can also judge whether the operation by the user is a search demanding operation of the POI information or not. In this case, the operation judging part 11 allows the display controlling part 15 to execute processing for displaying the search of the POI information and the processing search results.

Moreover, the configuration of the functional block shown in FIG. 1 is only an example, and the configuration thereof is not limited to this. For example, the configuration where the information integrating part 12 and the information detailing part 13 have at least one part of functions of the displayed icon data forming part 14 or the display controlling part 15 is also possible.

### (Operational Example of Information Processing Apparatus 1)

Next, an operational example of the information processing apparatus 1 will be described with reference to the drawings.

### [Operational Example of Operation Judging Part 11]

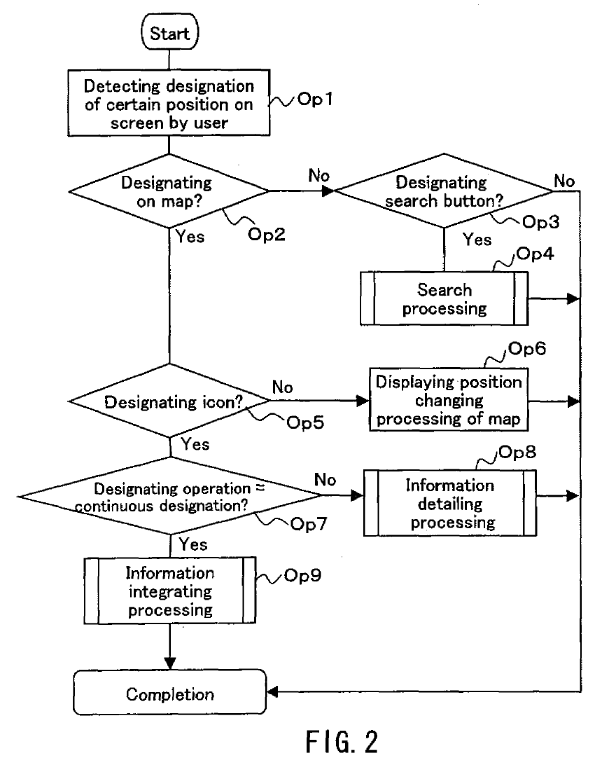

FIG. 2 is a flow chart showing an operational example of the operation judging part 11 in the case where the user designates a certain position on the screen of the display 3. As shown in FIG. 2, the operation judging part 11 detects the operation for designating the certain position on the screen of the display 3 by using the input apparatus 2 by the user (Op 1). For example, in the case where a touch panel is composed by unifying the input apparatus 2 and the display 3, the operation judging part 11 detects the operation by the user to touch the touch panel by his/her finger, and further detects a touching position as a designated position. The designated position can be detected as a value of a pixel coordinate on the screen, for example.

The operation judging part 11 determines a content of processing to be executed by the designating operation and the designated position that are detected in Op 1. The operation judging part 11 judges, for example, whether the designated position is on the map on the screen or not (Op 2). In the case where the designated position is not on the map (No in Op 2), the operation judging part 11 judges whether the searching button is designated or not (Op 3), and in the case where the search button is designated, it allows the display controlling part 15 to execute searching processing (Op 4). The searching processing will be described below in detail.

In the case where the operation judging part 11 judges that the designated position is on the map in Op 2 (Yes in Op 2), the operation judging part 11 judges whether the icon is designated or not (Op 5). The judgment whether the icon is designated or not can be performed by, for example, comparing the value of the pixel coordinate of the designated position and a displaying position of the icon represented by the displaying form data that is recorded in the icon attribution recording part 17.

In the case where the operation judging part 11 judges that the icon is not designated (No in Op 5), the operation judging part 11 notifies the designated icon to the display controlling part 15, and allows the display controlling part 15 to execute displaying position changing processing of the map (Op 6). The display controlling part 15 performs processing for changing the displaying range of the map to be displayed on the display 3 such that a position of the designated icon is a center of the screen.

In the case where the operation judging part 11 judges that the icon is designated (Yes in Op 5), the operation judging part 11 judges whether it is an operation showing the information integrating demand or an operation showing the information detailing demand, depending on whether the icon designating operation is an operation in which the designation is performed twice continuously in a predetermined period of time or not (Op 7). For example, in the case where the operation detected in Op 1 is an operation in which a finger touches an icon displaying position twice or more continuously in the predetermined period of time, the operation judging part 11 can judge that the operation is the information integrating demand, and on the other hand, in the case where the operation detected in Op 1 is an operation in which the finger touches once in the predetermined period of time, the operation judging part 11 can judge that the operation is the information detailing demand. A condition of the operation for Judging whether the operation is the information detailing demand or the information integrating demand is predetermined, and is necessary to be known by the user. It should be noted that the method for judging whether the designating operation is the operation showing the information integrating demand or the information detailing demand is not limited to the above-described example.

In the case where the operation judging part 11 judges that the operation detected in Op 1 is the operation in which the designation is performed twice or more continuously in the predetermined period of time (Yes in Op 7), the operation judging part 11 judges that the operation is for the information integrating demand, notifies the designated icon to the information integrating part 12, and allows the information integrating part 12 to execute the information integrating processing (Op 9).

Whereas, in the case where the operation judging part 11 judges that the operation detected in Op 1 is the operation in which the designation is performed only once in the predetermined period of time (No in Op 7), the operation judging part 11 judges that the operation is for the information detailing demand, notifies the designated icon to the information detailing part 13, and allows the information detailing part 13 to execute the information detailing processing (No in Op 7).

As described above, according to the processing shown in FIG. 2, the operation judging part 11 can detect the operation designated by the user, and can judge whether the designating operation is for demanding either of search processing (Op 4), processing for changing the displaying range of the map (Op 6), the information detailing processing (Op 8) or the information integrating processing (Op 9).

It should be noted that the judging method of the operation judging part 11 is not limited to the processing shown in FIG. 2. For example, in the case where the input apparatus 2 is a pointing device such as a mouse, the operation judging part 11 can detect an operation in which the user moves a cursor that is displayed on the display 3 and click it, and can judge the processing demanded by the user by the operation. Moreover, for example, in the case where the input apparatus 2 is a voice input apparatus such as a microphone, the operation judging part 11 may recognize a voice input by the user, and may judge the processing demanded by the user, based on a recognition result.

### [Example of Search Processing]

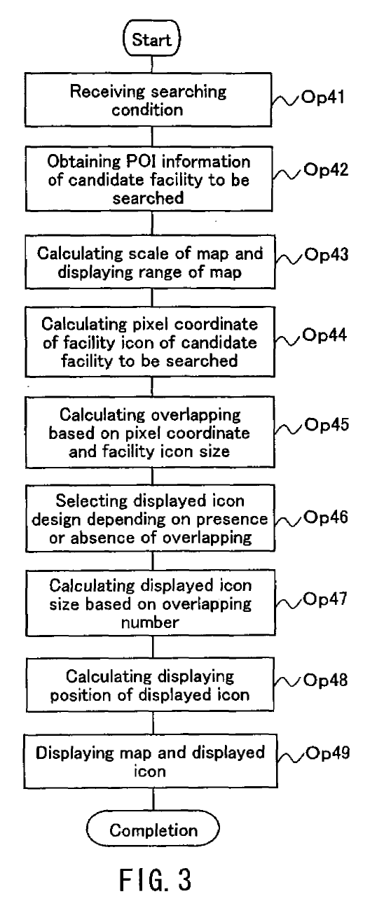

An example of the search processing in the case where the operation judging part 11 judges that the user performs the operation for demanding the search processing (Yes in Op 3) in the flow chart shown in FIG. 2 will be described. FIG. 3 is a flow chart showing a processing content of the search processing in Op 4 of FIG. 2.

As shown in FIG. 3, when the operation judging part 11 instructs the execution of the search processing to the display controlling part 15, the display controlling part 15 allows the display 3 to display a screen for the user to input a search condition, and receives an input of the search condition by the user (Op 41). Herein, as an example, a case where the user inputs, by using the input apparatus 2, “temple and shrine” as a genre of a facility and “within 300 km from the present position” as a regional area to be searched as the search conditions, in order to search a destination for leisure by using the car navigation apparatus will be described.

The operation judging part 11 refers the POIDB of the map recording part 4 based on the input search condition, and obtains POI information of a candidate to be searched (Op 42). For example, the POIDB includes a facility table in which information on the facility is recorded as the POI information. The operation judging part 11 can obtain information on a facility that satisfies the input search condition from the facility table. Herein, an example of the content of the data that is recorded into the facility table will be shown in Table 1 below.

TABLE 1

| | | map | | |
|---|---|---|---|---|
| | | positional | | |
| facility | | coordinate | | |
| information | | (longitude, | facility | |
| ID | genre | latitude) | name | address |
| 1 | temple and | (***, ***) | *** | . . . , ** City, ** |
| | shrine | | temple | Prefecture |
| 2 | temple and | (---, ---) | --- shrine | . . . , -- City, -- |
| | shrine | | | Prefecture |
| 3 | temple and | (xxx, xxx) | xxx | . . . , xx City, xx |
| | shrine | | temple | Prefecture |
| . . . | . . . | . . . | . . . | . . . |

In the example of the facility table shown in Table 1 above, a facility information ID, a genre of the facility, a map positional coordinate (longitude, latitude), a facility name and an address are recorded for each facility. For example, in the case where the search condition is as described in the above example, the operation judging part 11 extracts IDs of facilities whose map positional coordinates are within 300 km from the present position, as the facility information IDs of the candidate facilities to be searched, from the facilities in the facility genre of “temple and shrine” (the facilities with the facility information IDs of “1” to “3” in Table 1), and send them to the display controlling part 15. Incidentally, in the case where there is no input of “within 300 km from the present position” as the regional area to be searched, for example, all of the facilities in the genre of “temple and shrine” in the facility table (for example, all of the temples and shrines in Japan) are listed as the candidates to be searched.

When the display controlling part 15 receives the facility information ID of the facility as the candidate to be searched, the display controlling part 15 obtains the map positional coordinates (longitude, latitude) of the facilities as the candidates to be searched from the facility table. Then, it calculates a scale and a displaying range of the map that can display all of the facilities that are the candidates to be searched at the obtained map positional coordinates in one screen of the map (Op 43). Specific examples of the calculation of the scale and the displaying range of the map will be described below.

The display controlling part 15 calculates a minimum quadrangle enclosing all of the facilities at the obtained map positional coordinates. This quadrangle represents a desired displaying range. Moreover, two sidelines of this quadrangle are parallel with a south-north direction, and other two sidelines of this quadrangle are parallel with a east-west direction. The display controlling part 15 calculates map positional coordinates (longitude, latitude) of four corners of the quadrangle that shows such a desired displaying range, and sends them to the displaying attribution calculating part 151. The displaying attribution calculating part 151 determines a scale and a displaying position of the map from the map positional coordinates (longitude, latitude) of the four corners of the quadrangle showing the desired displaying range.

The displaying attribution calculating part 151 calculates the scale of the map and the displaying position on the map for displaying the desired displaying range that is represented by the map positional coordinates (longitude, latitude) of the four corners of the quadrangle, within a displaying range (pixel) of the display 3.

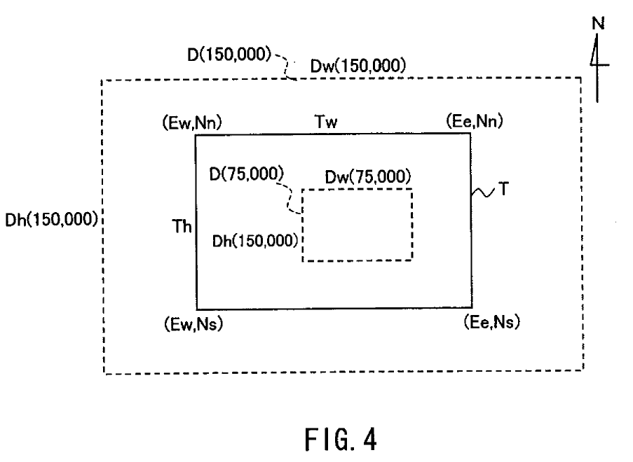

Firstly, a calculation example for obtaining the scale will be described with reference to FIG. 4. A quadrangle shown in FIG. 4 is an example of a quadrangle showing the desired displaying range. Four corners of the quadrangle T in south east, south west, north east and north west are represented by map positional coordinates (Ee, Ns), (Ew, Ns), (Ee, Nn) and (Ew, Nn), respectively. The displaying attribution calculating part 151 obtains actual distances Tw and Th that respectively correspond to a width and a height of the quadrangle T, from a difference between the map positional coordinate (Ee, Ns) of the south-east corner and the map positional coordinate (Ew, Nn) of the north-west corner, by utilizing spherical trigonometry.

Here, it is assumed that stages of the scale of the map to be displayed on the display 3 is predetermined as, for example, 1/900,000, 1/300,000, 1/150,000, 1/75,000, . . . , 1/1,500 by the navigation apparatus. The predetermined stages of the scale are recorded in the displaying attribution recording part 16, for example. In the case where the scale is shown in a fraction as described above, as the denominator is larger, the scale is smaller. As the scale is smaller, the displaying range of the map to be displayed on the display 3 is wider. Incidentally, a maximum scale value in the navigation apparatus is a largest value among the scales of the map that can be displayed by the navigation apparatus.

The displaying attribution calculating part 151 obtains actual distances Dwn and Dhn that respectively correspond to the width and the height of the displaying range at each stage of the scale 1/n, from a pixel number of the displaying region of the display 3, and the displaying attribution calculating part 151 compares Dwn and Dhn with Tw and Th, respectively, with respect to each stage of the scale 1/n. For example, the displaying attribution calculating part 151 decreases the scale 1/n by one stage from the maximum scale value 1/1500 so as to obtain a scale 1/N that provides DwN≧Tw and DhN≧Th. That is, the scale 1/N is a scale to be obtained.

In FIG. 4, as an example, a displaying range D (75,000) with a scale of 1/75,000 and a displaying range D (150,000) with a scale of 1/150,000 that is smaller than 1/75,000 by one stage are shown by quadrangles in dotted line, respectively. In this case, in the displaying range D (75,000) with the scale of 1/75,000, Dw (75,000)<Tw and Dh (75,000)<Th are satisfied, whereas, in the displaying range D (150,000) with the scale of 1/150,000 that is smaller than 1/75,000 by one stage, Dw (150,000)≧Tw and Dh (150,000)≧Th are satisfied. Thus, the displaying attribution calculating part 151 is a scale for obtaining 1/150,000. It should be noted that, in the case of reaching the smallest scale, the smallest scale is the scale to be obtained.

Next, a calculation example for obtaining the displaying range will be described below. The displaying attribution calculating part 151 calculates a map positional coordinate (longitude, latitude) of a central position of the quadrangle T showing the desired displaying range, that is, ((Ee+Ew)/2, (Ns+Nn)/2). The displaying attribution calculating part 151 calculates a quadrangle having a width and a distance of heights that respectively are DwN and DhN at the above-described scale of 1/N, which is the quadrangle having the center at ((Ee+Ew)/2, (Ns+Nn)/2), by utilizing the spherical trigonometry, for example. The quadrangle may be determined as a quadrangle showing the displaying range to be obtained. Incidentally, the method for calculating the displaying range is not limited to the above-described calculating method assuming that the central position of the desired displaying range is the central position of the displaying range as the example described above.

From the calculation described above, the scale of the map and the displaying range of the map to be displayed in the displaying region are obtained. Incidentally, the calculating methods of the scale and the displaying region of the map are not limited to those in the example described above. Moreover, as the method for calculating the scale and the displaying region of the map to be displayed in the displaying region of the display 3, other known methods can be used.

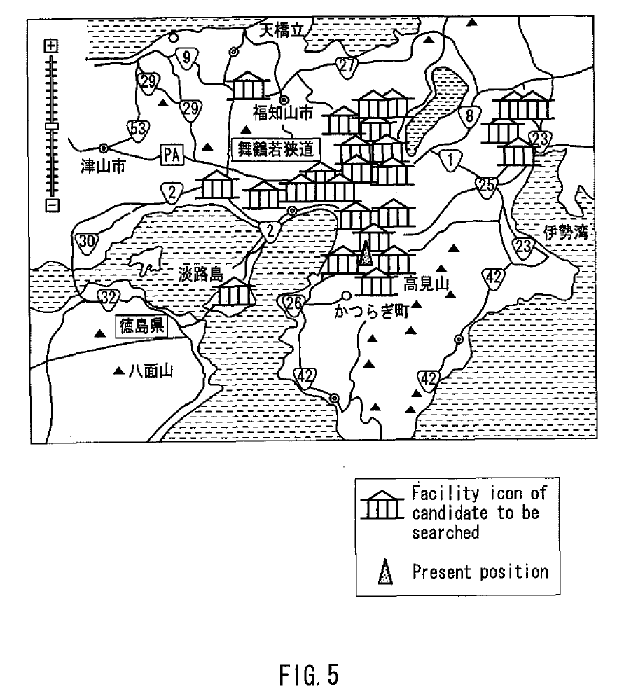

FIG. 5 is a view showing an example of a map to be displayed with the scale and the displaying range that are obtained as described above and an icon. In the displaying example shown in FIG. 5, one facility (temple and shrine) is represented by an icon showing one facility (hereinafter, the icon representing one facility is called a single facility icon). Moreover, either of the single facility icons have the same size. Thus, in a region where a lot of temples and shrines exist such as Kyoto and Nara, the single facility icons are overlapped, and cover the map.

Then, the integrated information extracting part 141 extracts overlapping icons in Op 44 and Op 45 described below, and the icon calculating part 142 generates appropriate displaying form data of the icons so as not to display the single facility icons being overlapped in Op 46 to Op 48.

Herein, a case where the integrated information extracting part 141 calculates the overlapping of the displayed icons, and generates displaying form data of an integrated icon representing by integrating the icons that are overlapped with each other will be described as an example. Firstly, in Op 44, the integrated information extracting part 141 calculates a pixel coordinate of a single facility icon of the candidate facility to be searched included in the map that is displayed with the scale and the displaying range calculated by the display controlling part 15 in Op 43. Herein, the pixel coordinate is a coordinate that shows a position in the screen of the display 3 by pixel, and a two-dimensional coordinate having an original point that is a predetermined reference position in the screen. Thus, the pixel coordinate of the single facility icon shows a position where the single facility icon is displayed in the screen of the display 3. The integrated information extracting part 141, for example, obtains a map positional coordinate Longitude, latitude) of the candidate facility to be searched that is included in the displaying range from the facility table, and calculates a position in the screen to which the map positional coordinate corresponds, thereby calculating the pixel coordinate of the single facility icon of the candidate facility to be searched.

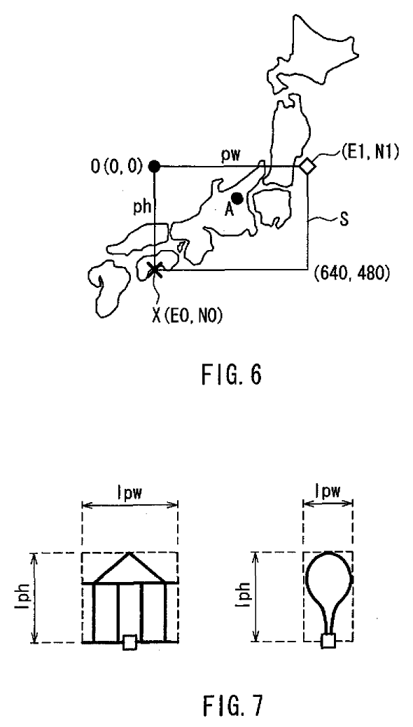

Here, an example of calculating a pixel coordinate of a single facility icon showing a facility at a point A will be described as one example. FIG. 6 is a view for explaining a calculation example of the pixel coordinate. In FIG. 6, an example of the displaying range S that is calculated in Op 43 is shown. In FIG. 6, a map positional coordinate (E0, N0) at a point represented by a cross mark denotes a minimum map positional coordinate (longitude, latitude) in the displaying range S, and a map positional coordinate (E1, N1) at a point represented by a diamond mark denotes a maximum map positional coordinate (longitude, latitude) in the displaying range S. A width (pixel number) of the displaying range S is denoted by pw, a height (pixel number) of the displaying range S is denoted by ph, and a map positional coordinate (longitude, latitude) at the point A is denoted by (EA, NA). In this case, a pixel coordinate (XA, YA) of the point of the facility A can be obtained by, for example, formulae (1) and (2) described below. It should be noted that, herein, a pixel at a left top end of the displaying range S is assumed to be an original point O (0, 0) of the pixel coordinate, as an example.

XA=(EA−E0)×pw/(E1−E0) (1)

YA=−(NA−N1)×ph/(N1−N0) (2)

Herein, XA and YA are integers.

It should be noted that the method for calculating the pixel coordinate is not limited to the above-described example, and other known methods can be used.

Next, in Op 45, the integrated information extracting part 141 detects the single facility icons that are displayed being overlapped in the case of displaying the single facility icons on the pixel coordinate calculated in Op 44. The integrated information extracting part 141 calculates a range of the pixel (the displaying region for the icons) that is occupied when the single facility icons are displayed, for example, from the pixel coordinates of the single facility icons and icon sizes that are shown by the displaying form data recorded in the icon attribution recording part 17. The integrated information extracting part 141 compares the respective displaying regions of the single facility icons in the displaying range, thereby obtaining data showing whether the single facility icons are overlapped or not.

As described above, the presence or absence of the overlapping of the single facility icons are judged based on the fact whether the displaying regions of the single facility icons showing the respective facilities are overlapped with the displaying region of the other single facility icon or not. The judging method of the overlapping of the icons is not limited to this.

FIG. 7 is a view showing an example of a relationship between the pixel coordinate of the icon and the displaying region of the icon. In the figure, a square mark represents the pixel coordinate of the icon. FIG. 7 is an example of the case where the single facility icon is displayed such that a center of a lower sideline of the icon displaying region of the single facility icon is the pixel coordinate of the single facility icon. As described above, the relationship between the pixel coordinate and the displaying region of the icon is predetermined. Also, the icon size of the icon shown in FIG. 7 is represented by, for example, a width (pixel number) Ipw and a height (pixel number) Iph of the displaying region of the icon.

The integrated information extracting part 141 checks whether all of the single facility icons of the candidate facilities to be searched in the displaying range that are calculated in Op 43 are overlapped with other single facility icon or not. As a result, the integrated information extracting part 141 records data that shows the overlapping relationship of the single facility icons of the candidate facilities to be searched, as a overlapping result table, into the icon attribution recording part 17. Table 2 below is a table showing an example of the overlapping result table that represents the overlapping relationship of the single facility icons of the candidate facilities to be searched.

TABLE 2

| single facility | facility | pixel | overlapping |
|---|---|---|---|
| icon ID | information ID | coordinate | number |
| 1 | 1 | (10, 200) | none |
| 2 | 2 | (***, ***) | 1 |
| 3 | 3 | (***, ***) | 1 |
| 4 | 11 | (***, ***) | 1 |
| 5 | 15 | (***, ***) | 2 |
| 6 | 49 | (***, ***) | 2 |
| . . . | . . . | . . . | . . . |

In the overlapping result table shown in FIG. 2 above, the single facility icon ID, the facility information ID, the pixel coordinate and the overlapping number are recorded for each single facility icon. In the overlapping result table in Table 2 above, it means that the single facility icons with the same overlapping number are overlapped with each other. That is, the overlapping result in Table 2 described above shows that the three single facility icons with the single facility icon IDs of 2, 3 and 4 are overlapped with one another, and the two single facility icons with the single facility icon IDs of 5 and 6 are also overlapped with each other. It should be noted that the data showing the overlapping relationship of the icons is not limited to the example shown in Table 2 above.

Next, the icon calculating part 142 determines an icon design of the icon to be displayed (hereinafter, called a displayed icon) based on the overlapping result that is obtained in Op 45 (Op 46). In the present embodiment, as an example of the icon design, a set of image data of the single facility icon that represents one facility and a set of image data of the integrated icon that represents by integrating a plurality of the facilities are prepared in advance. The sets of the image data for these icon designs are recorded as, for example, icon files in the icon attribution recording part 17 in advance. The icon calculating part 142 can assign, for example, the icon design of the single facility icon to a single facility icon that is not overlapped (its overlapping number is “none”) in Table 2, and can collectively assign one integrated icon to the single facility icons that are overlapped (its overlapping number is not “none” in Table 2”).

It should be noted that the icon designs are not limited to the single facility icon and the integrated icon as shown in the example described above. For example, it is also possible to record various sets of the image data of the single facility icons that are different according to kinds of the facilities, and determine the icon designs depending on the kinds of the facilities. For example, in the case where the kind of the facility is a “temple and shrine”, a landmark representing the temple and shrine can be assigned as the icon design of the single facility icon.

Moreover, the icon calculating part 142 determines the icon size of the displayed icon based on the overlapping result that is obtained in Op 45 (Op 47). In the case where the displayed icon is the integrated icon, for example, the icon calculating part 142 can determine the icon size of the integrated icon according to the number of the single facility icons that are overlapped (that is, the number of facilities represented by the integrated icon by integration, which is hereinafter called an overlapping facility number). That is, as the overlapping facility number is larger, the icon calculating part 142 can increase the icon size of the integrated icon. An example of a method for determining the icon size will be described below.

For example, the case where a smallest size S(min) and a largest size S(max) are determined as the size of the integrated icon in advance, and are recorded in the icon attribution recording part 17 will be described. In this case, for example, the minimum size S(min) of the integrated icon is set for the icon size of the single facility icon. The icon calculating part 142 can calculate an icon size S(integrated) of the integrated icon based on the overlapping facility number by, for example, utilizing formulae (3) and (4) below. It should be noted that, in the formula (3) below, a maximum value of the overlapping facility number represents an overlapping facility number of the integrated icon that has the largest overlapping facility number, among integrated icons to be displayed on one screen.

m=(S(max)−S(min))/((maximum value of overlapping facility number)−2) (3)

S(integrated)=S(min)+m×((overlapping facility number)−2) (4)

It should be noted that the method for determining the icon size of the displayed icon is not limited to the example described above. For example, a plural kinds of image data for the integrated icons (for example, a large size, a medium size and a small size) can be recorded in the icon attribution recording part 17. In this case, the icon calculating part 142 can also determine the icon size of the individual integrated icon by, for example, calculating an average value of the overlapping facility numbers of the integrated icons that are displayed in one screen (average overlapping facility number) and a standard deviation thereof, and comparing these values with the overlapping facility number of the individual integrated icon. For example, the icon calculating part 142 can define an icon size of this integrated icon as the middle size in the case where an overlapping facility number G of one integrated icon satisfies a following formula:

(average overlapping facility number)−(standard deviation)≦G≦(average overlapping facility number)+(standard deviation),

the icon calculating part 142 can define the icon size of this integrated icon as the small size in the case of satisfying a following formula:

(average overlapping facility number)−(standard deviation)>G,

and the icon calculating part 142 can define the icon size of this integrated icon as the large size in the case of satisfying a following formula:

(average overlapping facility number)+(standard deviation)<G,

Next, the icon calculating part 142 calculates a displaying position of the displayed icon (Op 48). The icon calculating part 142 determines a displaying position of a displayed icon of a single facility icon that is not overlapped directly to be the pixel coordinate in Table 2 above. In the case where the displayed icon is an integrated icon, the icon calculating part 142 calculates an average of pixel coordinates of respective single facility icons that are integrated by the integrated icon and overlapped, and can determine this average to be the pixel coordinate of the integrated icon, that is, the displayed icon. The icon calculating part 142 can utilize a predetermined relationship as the example shown in FIG. 7, thereby determining the icon displaying coordinate from the pixel coordinate and the icon size.

Table 3 below is a table showing an example of an overlapping controlling table for recording the design, the icon size and the displaying position of the displayed icon that are calculated by the icon calculating part 142 in Op 46 to Op 48. In the example shown in Table 3 below, a displayed icon ID, an overlapping facility number, single facility icon IDs of overlapping facilities, an icon file name, a pixel coordinate and an icon size of each displayed icon are recorded. The icon file name is a file name of image data that shows the icon design of the displayed icon. Moreover, the overlapping controlling table is recorded in the icon attribution recording part 17, for example. The pixel coordinate is a coordinate for determining the displaying position of the icon as shown in FIG. 7, for example. The icon size is a value that represents a width and a height of the icon in pixel number, for example.

TABLE 3

| | | single facility | | | |
|---|---|---|---|---|---|
| | overlapping | icon ID of | | | icon size |
| displayed | facility | overlapping | | pixel | (width, |
| icon ID | number | facility | icon file name | coordinate | height) |
| 1 | 1 | 1 | single facility icon.img | (10, 200) | (8, 8) |
| 2 | 3 | 2, 3, 4 | integrated icon.img | (***, ***) | (10, 10) |
| 3 | 2 | 5, 6 | integrated icon.img | (***, ***) | (8, 8) |
| . . . | . . . | . . . | . . . | . . . | . . . |

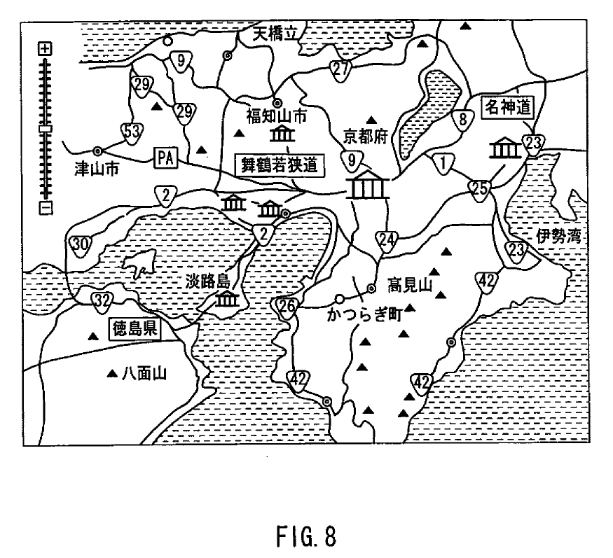

The display controlling part 15 refers the overlapping controlling table shown in Table 3, and allows the display 3 to display the icon of the icon ID whose information pixel coordinate is included in the displaying range obtained in Op 43, together with the map (Op 49). FIG. 8 is a view showing an example of the screen displayed by the display controlling part 15. As shown in FIG. 8, the single facility icons that are overlapped in FIG. 5 are displayed as an integrated icon by integration. Thereby, visibility of the map is improved.

### [Example of Information Detailing Processing]

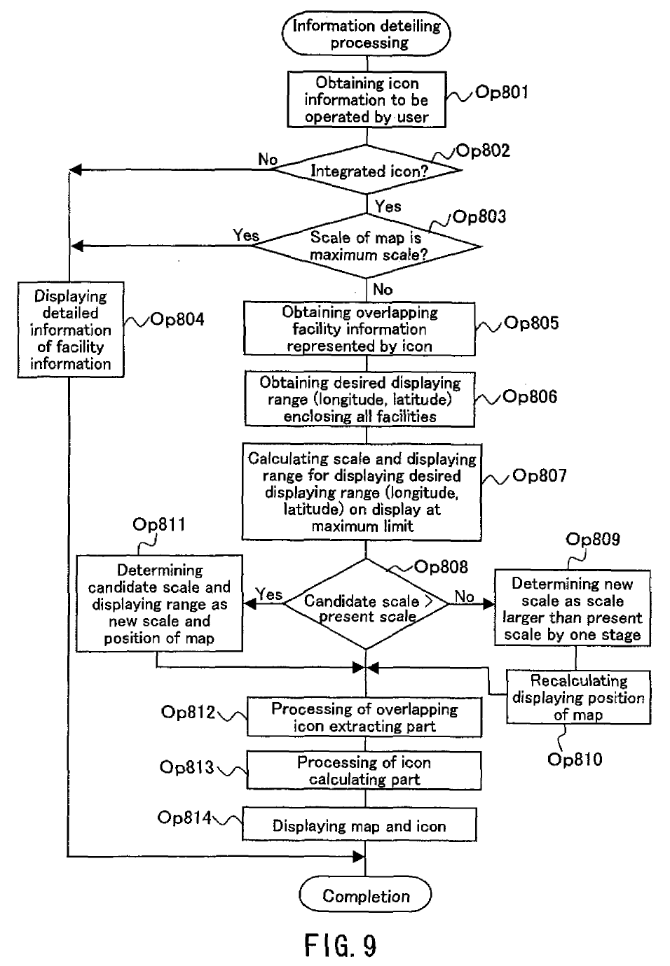

Next, an example of information detailing processing in the case where the operation judging part 11 judges that the user performs an operation for demanding the information detailing processing in the flow chart shown in FIG. 2 (No in Op 7) will be described. FIG. 9 is a flow chart showing a content of the information detailing processing in Op 8 of FIG. 2.

In the processing shown in FIG. 9, the information detailing part 13 receives a notice of an icon that is designated by the user from the operation judging part 11 (Op 801). In the case where the icon designated by the user is not the integrated icon (No in Op 802), or in the case where the scale of the map that is currently displayed on the display 3 is the maximum scale (Yes in Op 803), detailed facility information of this icon is obtained from the facility table shown in Table 1 above, and is displayed on the display controlling part 15 (Op 804). Incidentally, the current scale is recorded in the map attribution recording part 16.

In the case of Yes in Op 803, that is, in the case where the icon designated by the user is the integrated icon and the current scale is not the maximum scale, the information detailing part 13 obtains information on a plurality of facilities that are integrated by the integrated icon (Op 805). As one example, the case where the integrated icon with the icon ID of “2” in the overlapping controlling table of Table 3 above is to be operated will be described below. The information detailing part 13 obtains single facility icon IDs “2, 3, 4” of the plurality of the facilities integrated by the integrated icon that is designated by the user, which are the overlapping facilities, from the overlapping controlling table shown in Table 3 above. Then, the information detailing part 13 obtains the facility information IDs “1, 2, 11” that correspond to the single facility icon IDs “2, 3, 4”, from the overlapping result table shown in Table 2, and obtains map positional coordinates (longitude, latitude) of the overlapping facilities from the facility table of Table 1 by using the facility information IDs “1, 2, 11”.

Next, the information detailing part 13 obtains a minimum quadrangle enclosing the map positional coordinates longitude, latitude) of these overlapping facilities, as the desired displaying range (Op 806). Thereafter, the information detailing part 13 allows the display controlling part 15 to calculate a scale and a displaying range for displaying the desired displaying range (Op 807). That is, the information detailing part 13 transmits the quadrangle showing the desired displaying range to the displaying attribution calculating part 151, and the displaying attribution calculating part 151 obtains the scale and the displaying range on the map that enable the quadrangle to be displayed with maximum expansion on the displaying region of the display 3. This calculation can be performed similarly to the processing of Op 43 in FIG. 3 described above.

In the case where the scale that is obtained by the processing of the displaying attribution calculating part 151 in Op 807 is equal to the present scale or smaller (No in Op 808), the information detailing part 13 increases the scale by one step (Op 809), transmits the scale that is increased by one step and the pixel coordinate of the integrated icon that is designated by the user to the displaying attribution calculating part 151, and allows the displaying attribution calculating part 151 to calculate a displaying range of the map which shows the pixel coordinate of the integrated icon at a center of the screen (Op 810). The information detailing part 13 records the scale that is increased by one step in Op 809 and the displaying range that is calculated in Op 810 as a new scale and a new displaying range into the map attribution recording part 16.

In the case of Yes in Op 808, the information detailing part 13 records the scale and the displaying range obtained in Op 807 as a new scale and a new displaying range into the map attribution recording part 16 (Op 811). As described above, the displaying range and the scale that enable to cover the map positional coordinates (longitude, latitude) of the facilities, which respectively show the plural sets of the facility information that are represented by the integrated icon by the integration, are calculated.

The integrated information extracting part 141 checks the presence or absence of the overlapping of the single facility icons representing the facilities in the new displaying range that is calculated in Op 810 or Op 811 (Op 812). The processing of Op 812 can be performed similarly to the processing of Op 44 and Op 45 in the flow chart shown in FIG. 3. Based on a result of the check of the presence or absence of the overlapping in Op 812, the icon calculating part 142 selects a design of the displaying icon, calculates an icon size and a displaying position, and records them into the icon attribution recording part 17 (Op 813). The processing of Op 813 can be performed similarly to those of Op 46 to Op 48 in the flow chart shown in FIG. 3. And, the display controlling part 15 allows the display 3 to display the map and the displaying icon, based on the design, the icon size and the displaying position of the displaying icon that are recorded in the icon attribution recording part 17 and the new scale and the new displaying range that are recorded in the map attribution recording part 16 (Op 814). Thereby, the integrated icon designated by the user is displayed being detailed with the new displaying range and the new scale. Thus, the plurality of the icons showing the facility information that are included in the integrated icon designated by the user are displayed effectively in the displaying range. That is, the map and the detailed icon are displayed with the appropriate scale and displaying range. Moreover, since newly displayed icons are also displayed without being overlapped, the map that is visible for the user is displayed.

### [Example of Information Integrating Processing]

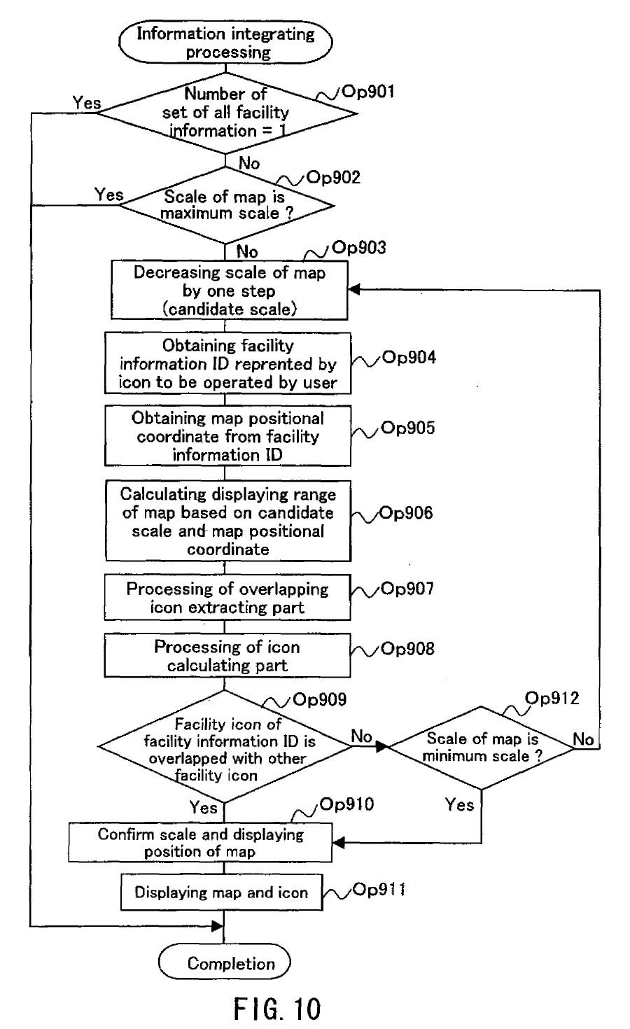

Next, an example of the information integrating processing, in the case where the operation judging part 11 judges that the user performs an operation for demanding the information integrating processing (Yes in Op 7) in the flow chart shown in FIG. 2, will be described. FIG. 10 is a flow chart showing the processing content of the information integrating processing in Op 9 in FIG. 2.

In the example shown in FIG. 10, the information integrating part 12 performs the integrating processing by decreasing the scale of the map to an extent that the icon designated by the user is overlapped with other facility icon, and displaying the overlapped icons as an integrated icon.

In the case where the number of the icons displayed in the whole map that is presently displayed (herein, the total number of the facility icons that show temples and shrines, as an example) is only one (Yes in Op 901), or in the case where the scale of the map is a minimum scale among scales that can be set by the car navigation apparatus (Yes in Op 902), the processing is completed without performing the integrating processing. Incidentally the scale that can be set by the car navigation apparatus is recorded in, for example, the icon attribution recording part 17 in advance. Moreover, it should be noted that the presently displayed map is a map that is displayed on the display 3 at the time when the user performs the operation for the information integrating demand.

A case where the integrated icon whose displayed icon ID in the overlapping controlling table of Table 3 above is “2” is to be operated will be described below as an example.

The information integrating part 12 sets the scale of the candidates to be a scale that is smaller than the scale of the presently displayed map by one step (Op 903). The information integrating part 12 obtains the single facility icon IDs “2, 3, 4” of the plurality of the facilities that are integrated by the integrated icon (the displayed icon ID is “2”) that is designated by the user from the overlapping controlling table shown in Table 3 above, and obtains the facility information IDs “1, 2, 11” that correspond to these facility icon IDs “2, 3, 4” from the overlapping result table shown in Table 2 above (Op 904). The information integrating part 12 obtains the map positional coordinates (longitude, latitude) of the facilities with the facility information IDs “1, 2, 11” from the facility table of Table 1 above by using the facility information IDs “1, 2, 11” (Op 905). The information integrating part 12 allows the display controlling part 15 to calculate a displaying range of the map which shows the map positional coordinates (longitude, latitude) of the facilities with the facility information IDs “1, 2, 11” at the center of the screen (Op 906).

The information integrating part 12 transmits the displaying range calculated in Op 906 and the scale of the candidate set in Op 903 to the integrated information extracting part 141 of the displayed icon data forming part 14. The integrated information extracting part 141 checks the presence or the absence of the overlapping of the single facility icons that are included in the transmitted displaying range (Op 907). The processing of Op 907 can be performed similarly to those of Op 44 and Op 45 in the flow chart shown in FIG. 3. Based on the result of Op 907, the icon calculating part 142 calculates a design, an icon size and a displaying position of the displayed icon, and records them into the icon attribution recording part 17 (Op 908). The processing of Op 908 can be performed similarly to those of Op 46 to Op 48 in the flow chart shown in FIG. 3.

The information integrating part 12 checks whether the single facility icons of the facility information IDs “1, 2, 11” are overlapped with a single facility icon other than those with the facility information IDs of “1, 2, 11” or not (Op 909).

In the case of No in Op 909, the information integrating part 12 further decreases the scale of the candidate of the map by more one step (Op 903), and repeats the processing of Op 904 to Op 908. As described above, each time when performing the processing of Op 904 to Op 908, the information integrating part 12 decreases the scale of the map by one step each, and finds a scale at which any of the single facility icons of the facilities with the facility information IDs “1, 2, 11” is overlapped with the single facility icon of the facility other than the facilities with the facility information IDs “1, 2, 11”. In the case where the scale of the candidate of the map is the minimum scale before the single facility icons are overlapped, the minimum scale is determined to be a new scale.

On the other hand, in the case of Yes in Op 909, the scale of the candidate is determined to be the new scale, the information integrating part 12 allows the displaying attribution calculating part 151 to calculate the displaying range of the map in which the map positional coordinate of the integrated icon designated by the user, that is, a barycenter of the map positional coordinates with the facility information IDs “1, 2, 11” is the center of the displaying screen (Op 910). Alternatively the information integrating part 12 may also allow the displaying attribution calculating part 151 to calculate the displaying range of the map such that the map positional coordinate (longitude, latitude) which corresponds to a displaying coordinate (pixel coordinate) Up of the position designated by the user corresponds to the displaying coordinate Up at the position designated by the user also at the new scale. The calculated new scale and displaying range are recorded into the map attribution recording part 16.

The display controlling part 4 allows the display 3 to display the map and the displayed icons, based on the designs, the icon sizes and the displaying positions of the displayed icons that are recorded in the icon attribution recording part 17, and the new scale and the displaying range that are recorded in the map attribution recording part 16 (Op 911).

Thereby, the icons designated by the user are integrated, and the map in a further wider range is displayed on the display 3 at the appropriate scale. Incidentally, the integrating processing is not limited to the example shown in FIG. 10.

### [Operation for Enhancing Visual Effect]

According to the information detailing processing and the information integrating processing described above, the scale and the displaying range of the map that is displayed on the display 3 can be switched. At this time, because of changing the scale of the map significantly, it may be difficult for the user to intuitively recognize the correspondence relationship of the displaying position between in the map before the switching and in the map after the switching. In such a case, the display controlling part 15 can realize the switching that is easy for the user to recognize the correspondence relationship of the displaying position by, for example, providing a visual effect as follows.

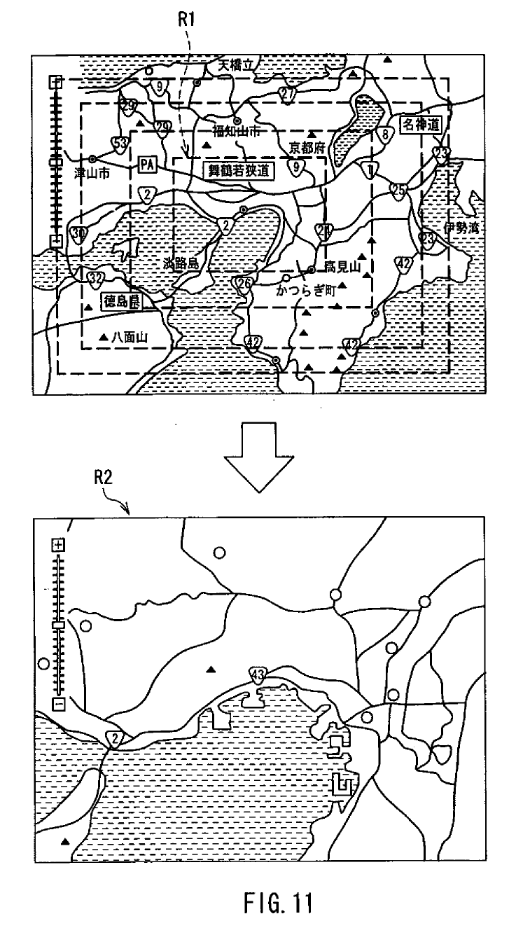

FIG. 11 is a view for explaining a state of the map displayed on the display 3 at the time of the detailing. The display controlling part 15 allows the map before the detailing (the map shown in an upper stage of FIG. 11) to display a region R1 near the position where the integrated icon is originally located, which becomes a displaying region after the detailing, by enclosing by a quadrangle in dotted line. Then, the display controlling part 15 gradually expands the quadrangle in dotted line to a region R2 that accords with the region R1 in the new map after the detailing (the map shown in a lower stage of FIG. 11) so as to achieve the new display, and controls the display 3 so as to erase the quadrangle in dotted line. Thereby, it becomes easier for the user to recognize the positional relationship before the detailing and after the detailing. Incidentally, at the time of integrating, the quadrangle in dotted line can be displayed so as to be reduced inversely to the detailing.

It should be noted that the displaying method for obtaining the visual effect is not limited to the above-described example. For example, as other displaying method, the display controlling part 15 may show animation for gradually expanding a bit map image near the integrated icon before the detailing into the size after the detailing, and may subsequently display the map so as to replace it. Moreover, the display controlling part 15 may show animation for gradually reducing the bit map image of the whole displaying screen before the integration into the size after the integration, and may subsequently display the map so as to replace it.

### Embodiment 2

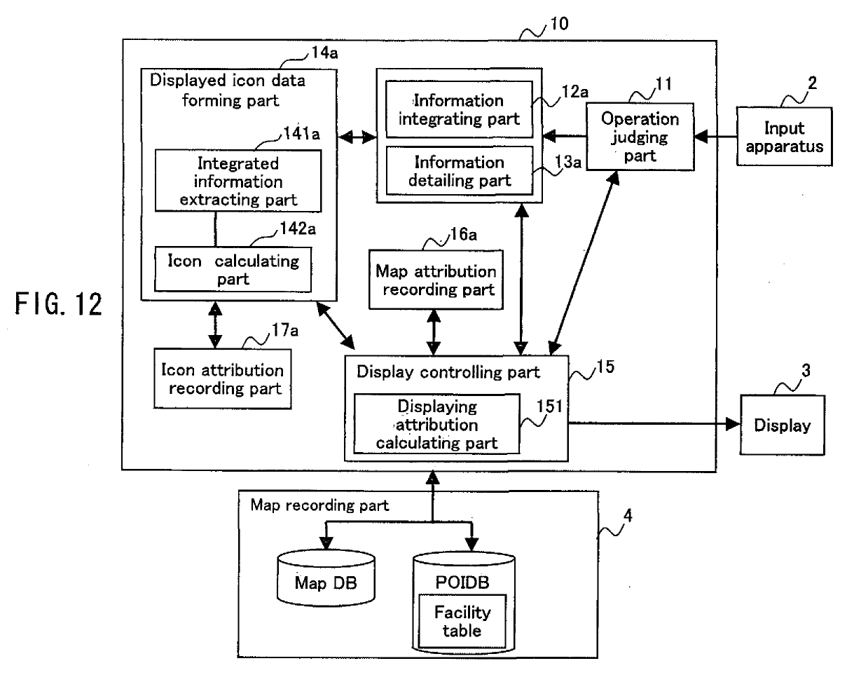

FIG. 12 is a functional block diagram showing a configuration of an information processing apparatus 10 according to the present embodiment. In FIG. 12, the functional block same as that in FIG. 1 is denoted by the same reference numeral. In the information processing apparatus 10, an information integrating part 12a, an information detailing part 13a and a displayed icon data forming part 14a have different functions from the information integrating part 12, the information detailing part 13 and the displayed icon data forming part 14 of the information processing apparatus 1 shown in FIG. 1, respectively. Moreover, structures of data that is recorded in a map attribution recording part 16a and an icon attribution recording part 17a are also different from those of the map attribution recording part 16 and the icon attribution recording part 17 of the information processing apparatus 1.

In the present embodiment, the displayed icon data forming part 14a adopts a method of dividing a map into partitions according to a scale of the map, and integrating and detailing facility information based on the partition, as another method for integrating and detailing an icon.

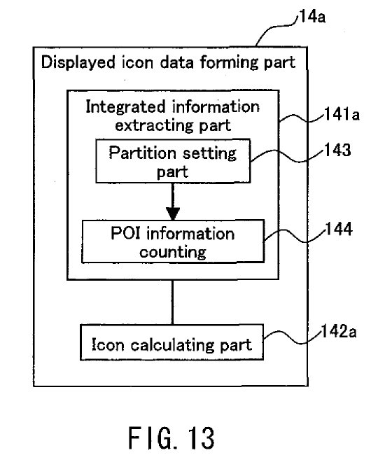

FIG. 13 is a functional block diagram showing a detailed structure of the displayed icon data forming part 14a. In the displayed icon data forming part 14a, an integrated information extracting part 141a includes a partition setting part 143 and a POI counting part 144. The partition setting part 143 receives a scale and a displaying range of the map from the information integrating part 12a or the information detailing part 13a, generates partition information on each partition in the case of dividing the map displayed with the scale and the displaying range into a plurality of the partitions, and records the partition information into the icon attribution recording part 17a. The POI information counting part 144 counts the number of sets of POI information included in each partition that shows partition information. The POI information counting part 144 can count the number of the sets of the POI information included in each partition, by referring the partition information that is generated by the partition setting part 143 and a POIDB that is recorded in the map recording part 4.

The icon calculating part 142a generates displaying form data of a displayed icon that is displayed with the map, based on the partition information that is generated by the partition setting part 143 and the number of the sets of the PO information included in each partition which is counted by the POI information counting part 144, and records the displaying form data into the icon attribution recording part 17a. In the case where each partition represented by the partition information includes a plurality of the sets of the POI information, the icon calculating part 142a generates the displaying form data of the integrated icon that represents the plurality of the sets of the POI information by integration, and in the case where each partition includes one set of the POI information, the icon calculating part 142a generates displaying form data of a single point icon that represents the POI information.

In FIG. 12, the information detailing part 13a receives an instruction for information detailing processing of the icon from the operation judging part 11, and performs the information detailing processing of the icon. More specifically the information detailing part 13a calculates a partition where the designated integrated icon is present as the desired displaying range, among the partitions of the map displayed on the display 3 when the user performs the information detailing demanding operation. The information detailing part 13a transmits the desired displaying range to the display controlling part 15, allows the display controlling part 15 to calculate a scale and a displaying range that enable to display the desired displaying range in one screen, and allows the map attribution recording part 16a to record them. Moreover, the information detailing part 13a allows the partition setting part 143 of the displayed icon data forming part 14a to generate the partition information on each partition that is obtained by dividing the map with the scale and the displaying range that are calculated by the display controlling part 15. Moreover, the icon calculating part 142a generates the displaying form data of the displayed icon in each partition shown by the partition information, and allows the icon attribution recording part 17a to record the displaying form data.

The information integrating part 12a receives an instruction for the information integrating processing of the icon from the operation judging part 11, and performs the information integrating processing. More specifically, the information integrating part 12a calculates a displaying range as the desired displaying range such that the displaying range, which is displayed on the display 3 when the user performs the information integrating demanding operation, corresponds to at least one partition in the map. The information integrating part 12a transmits the desired displaying range to the display controlling part 15, allows the display controlling part 15 to calculate a scale and a displaying range that enable to display the desired displaying range in one screen, and allows the map attribution recording part 16a to record them. Moreover, the information integrating part 12a allows the partition setting part 143 of the displayed icon data forming part 14a to generate partition information on each partition that is obtained by dividing the map with the scale and the displaying range that are calculated by the display controlling part 15. Further, the information integrating part 12a allows the icon calculating part 142a to generate displaying form data of the displayed icon in each partition shown by the partition information, and allows the icon attribution recording part 17a to record them.

### (Operational Example of Information Processing Apparatus 10)

In the information processing apparatus 10 shown in FIG. 12, the operation of the operation judging part 11 is similar to that in the flow chart shown in FIG. 2.

### [Example of Search Processing]

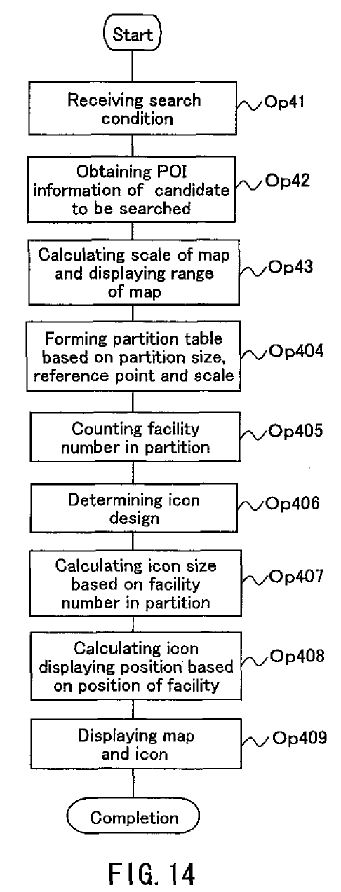

An example of search processing of the present embodiment in the case where the operation judging part 11 judges that the user performs an operation for demanding the searching processing (Yes in Op 3) in the flow chart shown in FIG. 2 will be described. FIG. 14 is a flow chart showing a processing content of the search processing in Op 4 in FIG. 2.

In FIG. 14, Op 41 to Op 43 are the same as Op 41 to Op 43 in FIG. 3. Herein, as an example, a case where the user inputs, by using the input apparatus 2, “temple and shrine” as a genre of facilities and “within 300 km from the present position” as a regional area to be searched as the search conditions, in order to search a destination for leisure by using the car navigation apparatus will be described similarly to Embodiment 1.

When the scale and the displaying range of the map that enables to display the facilities of the search candidates in one screen of the map are calculated in Op 43, the partition setting part 143 divides the map displayed with the scale and the displaying range that are calculated in Op 43 into a plurality of partitions, generates the information on each partition, and records the information into the partition information table (Op 404). For example, the partition setting part 143 determines a size of one partition based on a predetermined icon size, and divides the displaying range of the map into the plurality of the partitions based on a predetermined reference point on the map. Hereinafter, a specific example of the dividing processing by the partition setting part 143 will be described below.

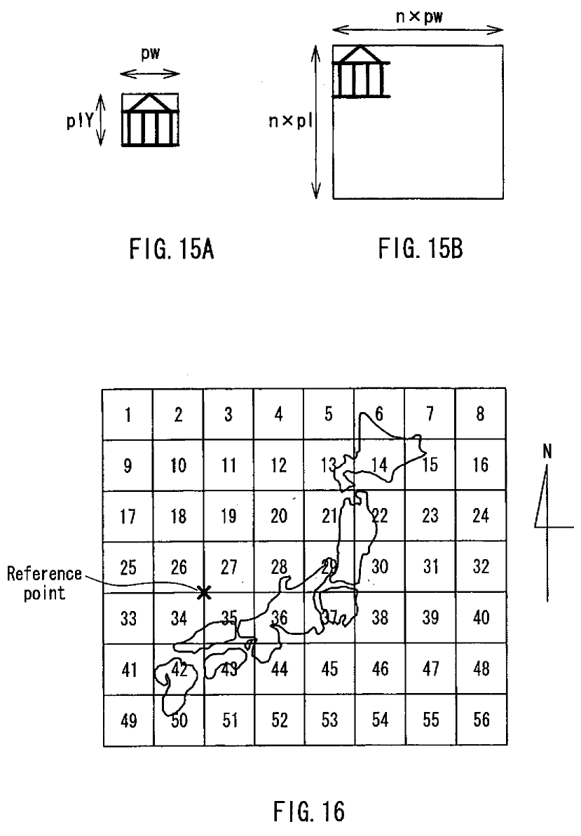

Firstly, the partition setting part 143 sets the size of one partition to be an integral multiple of a maximum size of the icon. The maximum size of the icon is, for example, recorded in the icon attribution recording part 17a in advance. FIG. 15A is a view showing an example of the maximum size of the icon, and FIG. 16B is a view showing an example of the size of one partition that is set according to the maximum size of the icon of FIG. 15A. In the example shown in FIG. 15A, the maximum size of the icon is pl pixels×pw pixels. Herein, the pixel is a unit for representing a size of an image that is displayed on the display 3. The size of one partition determined based on this maximum size is n×pl×n×pw (n is an integer of 1 or larger) as shown in FIG. 15B.

As described above, in the case where the unit of the maximum size of the icon is pixel, the partition setting part 143 converts the size shown in pixel into a size of the map (for example, a size represented by longitude, and latitude and an actual distance). This size of this map varies according to the scale. For example, assuming that pw is 40 pixels, pl is 40 pixels and n is 3, where the pw and the pl determine the maximum size of the icon, and when the size of one partition is represented in pixel, it is width of 120 pixels×length of 120 pixels. In the case where the number of pixels that corresponds to 1 cm of a paper in the map with a scale of 1/M is assumed to be Pm, an actual distance for 120 pixels is (120×M)/Pm (cm). Thus, the size of one partition of the map is {(120×M)/Pm}². As the scale is larger, M is smaller. Thus, in the case where Pm is constant regardless of the scale, as the scale is larger, the size of one partition of the map that corresponds to the size of one partition shown in pixel is smaller.

When determining the size of one partition of the map, the partition setting part 143 divides the displaying range of the map into partitions in the determined size, assuming a certain point (longitude, latitude) in the displaying range of the map as a reference point. For example, the partition setting part 143 divides the displaying range of the map into a plurality of the partition such that the reference point is one corner of a certain partition. FIG. 16 is a view showing an example of the partition that is set by the partition setting part 143. In the example shown in FIG. 16, a partition ID is provided to each partition. Herein, a corner at a left bottom end (a south-east corner) of a partition with a partition ID of 27 is the reference point.

The partition setting part 143 generates data representing the plurality of the partitions, and records the data into the partition information table, for example. The partition information table is, for example, a table to be recorded into the icon attribution recording part 17a. Table 4 below is a table showing an example of a data content to be recorded into the partition information table.

TABLE 4

map positional
coordinate

| partition | south-east | north-west |
|---|---|---|
| ID | coordinate | coordinate |
| 1 | (***, ***) | (***, ***) |
| 2 | . . . | . . . |
| . . . | . . . | . . . |

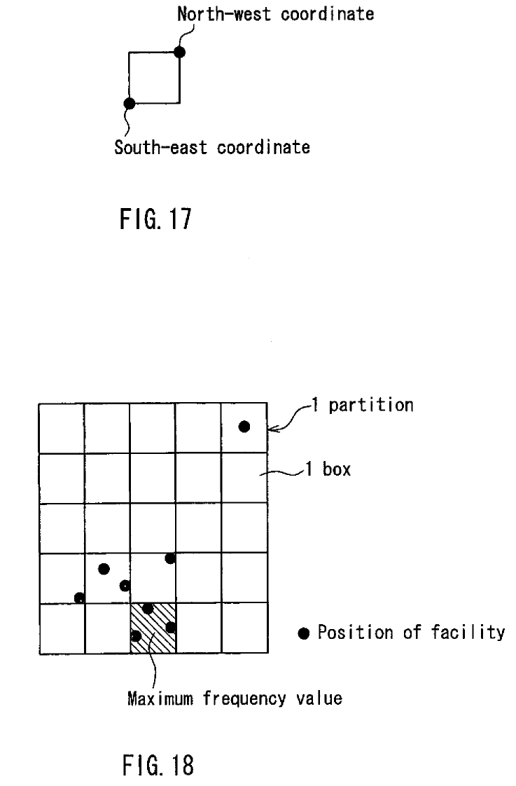

In the partition information table shown in Table 4 above, the partition ID and the map positional coordinate are recorded. The map positional coordinate is represented by the south-east coordinate and the north-west coordinate. Herein, it is assumed that a coordinate at a left bottom end is the south-east coordinate, and a coordinate at a right top end is the north-west coordinate in one partition, as shown in FIG. 17. It should be noted that the map positional coordinate is obtained by referring the map DB of the map recording part 4.

As described above, the partition setting part 143 divides the map into the plurality of the partitions according to the reference point, the scale, the displaying range and the pixel partition size of the map, and records the information showing each partition into the partition information table. The partition setting part 143 performs the above-described partition setting processing with regard to various scales and displaying ranges, and records the partition information table as shown in Table 4 every time when performing the partition setting processing. It should be noted that the case where the partition is a rectangle is explained in the above-described example, but a shape of one partition is not needed to be a rectangle.

As described above, when the partition is set, the POI information counting part 144 counts the number of the facilities of the candidates to be searched in each partition (Op 405). The POI information counting part 144 counts the number of sets of facility information in each partition by, for example, comparing the map positional coordinate of the facility information of the candidates to be searched (data in the facility table; see Table 1 above) with the map positional information of each partition in the partition information table shown in Table 4 above. The POI information counting part 144 may obtain the facility information of the facilities included in each partition from the facility table, and may further record it into the partition information table of Table 4 above. The POI information counting part 144 records, for example, the number of the sets of the facility information and facility information IDs in each partition into the partition information table.

Next, the icon calculating part 142a determines designs of displayed facility icons representing the facilities of the candidates to be searched that are included in each partition (Op 406). The icon calculating part 142a determines the designs of the displayed icons, based on the number of the facilities of the candidates to be searched in the partition that are counted in Op 405. In the present embodiment, as an example of the icon design, image data of a single facility icon that represents one facility and image data of an integrated icon that represents a plurality of facilities by integration are recorded in the icon attribution recording part 17a in advance. In this case, for example, in the case where there is only one facility as the candidate to be searched in the partition, the icon calculating part 142a assigns the single facility icon as the displayed icon representing the facility in the partition. In the case where the number of the facilities as the candidates to be searched included in the partition is two or more, the icon calculating part 142a can assign the integrated icon that represents two or more facilities by integration as the displayed icon in the partition. It should be noted that the design of the displayed icon is not limited to the single facility icon and the integrated icon as the example described above.

Moreover, the icon calculating part 142a determines the icon size of the displayed icon representing the facilities as the candidates to be searched that are included in each partition, based on the number of the facilities as the candidates to be searched in each partition (Op 407). For example, in the case where there is only one facility in the partition, the facility is represented by the single facility icon, and the icon size thereof is set in advance. For example, the icon size of the single facility icon is determined to be the same as a minimum size of the integrated icon in advance so as to be recorded into the icon attribution recording part 17a. In the case where there are a plurality of the facilities in the partition, the icon calculating part 142a may increase the icon size of the displayed icon (that is, the integrated icon) more, as the number of the facilities in the partition is larger. An example of a method for determining the icon size will be described below.

For example, a case where a maximum size S(max) and a minimum size S(min) of the icon are determined in advance, and are recorded in the icon attribution recording part 17a is described. In the case where there is one facility in the partition, the icon calculating part 142a allows the icon size of the single facility icon to accord with the minimum size S(min) of the integrated icon. In the case where there are a plurality of the facilities in the partition, the icon calculating part 142a can calculate the icon size S(integrated) of the integrated icon by utilizing, for example, formulae (5) and (6). A maximum value of the number of the facilities in the partition is the largest number of facilities that are included in a partition among the partitions displayed in one screen.

m=(S(max)−S(min))/((maximum value of number of facilities in partition)−2) (5)

S(integrated)=S(min)+m×((number of facilities in partition)−2) (6)

It should be noted that the method for determining the icon size is not limited to the above-described example. For example, a plurality of kinds of image data for the integrated icons (for example, a large size, a medium size and a small size) are recorded in the icon attribution recording part 17a in advance, and the icon calculating part 142a may select the image data of the facility icon according to the number of the facilities in the partition. Moreover, as still another method, the image data of the icon design for the single facility icon and the image data of the icon design for the integrated icon are not prepared separately, and the integrated icon in a minimum size may be used as the single facility icon. That is, in the case where there is only one facility in the partition, the minimum size of the integrated icon is assigned as the displayed icon, and in the case where there are two or more facilities in the partition, the size of the displayed icon (the integrated icon) may be varied according to the number of the facilities.

Moreover, the icon calculating part 142a calculates a displaying position of the single facility icon representing the facility as the candidate to be searched that is included in each partition (Op 408). The icon calculating part 142a can obtain the map positional coordinate of the facility in the partition by referring, for example, the facility table, and can determine the displaying position of the icon based on the map positional coordinate. In the case where the single facility icon represents that there is only one facility is present in the partition, for example, the icon calculating part 142a defines the map positional information (longitude, latitude) of the facility as the coordinate of the displaying position of the single facility icon. In the case where the displayed icon is the integrated icon, the icon calculating part 142a calculates an average value of the map positional coordinates (longitude, latitude) of the facilities included in the partition, and defines this average value as the coordinate of the displaying position of the integrated icon. Alternatively, it may adopt a method of analyzing a distributional condition of the facilities in the partition, and determining a coordinate of a central position of a region where the facilities are most dense as the coordinate of the displaying position of the integrated icon. For example, as shown in FIG. 18, the icon calculating part 142a divides one partition into a plurality of boxes, for example, 25 boxes equally, counts the number of facilities included in each box, and defines a coordinate of a central position of the box which includes the largest number of facilities as the coordinate of the displaying position of the integrated icon. In the example shown in FIG. 18, since the number of the facilities included in the box that is shown with oblique lines is three, which is the largest, the icon calculating part 142a can define the coordinate of the central point of the box shown with the oblique lines as the coordinate of the integrated icon displaying position.

It should be noted that the method for calculating the displaying position is not limited to the above-described example. Moreover, if displaying the displayed icon at the displaying position that is obtained by the above-described method of calculating the average value and the method shown in FIG. 18, the displayed icon may extend off from the partition and may be overlapped with an icon in a next partition. In this case, the icon calculating part 142a may readjust the position of the displayed icon such that the displayed icon can be displayed in the partition.

Since the coordinate of the displaying position that is obtained by the above-described method is the map positional coordinate (longitude, latitude), the icon calculating part 142a may add a coordinate that is obtained by converting this coordinate into a pixel coordinate, with the displaying position coordinate of the map positional coordinate (longitude, latitude), into the partition information table.

Table 5 below is a table showing an example of data contents in the case of adding and recording the information on the icon design, the icon size and the displaying position of the icon of the displayed icon that are obtained in Op 406 to Op 408 described above, into the partition information table shown in above Table 4. In Table 5 below, a partition ID, a map positional coordinate, facility information, a facility information ID, an icon file name, an icon map positional coordinate, a pixel coordinate and an icon size of each partition are recorded. The icon file name is a file name of image data of the icon design. The icon map positional coordinate represents the displaying position of the displayed icon in map positional coordinate (longitude, latitude), and the pixel coordinate represents the displaying position of the displayed icon in pixel.

TABLE 5

| | | | | | | | icon |
|---|---|---|---|---|---|---|---|
| | map | facility | facility | | icon map | | size |
| partition | positional | information | information | icon file | positional | pixel | (width, |
| ID | coordinate | number | ID | name | coordinate | coordinate | height) |
| 1 | . . . | 0 | (none) | (none) | (none) | (none) | (none) |
| . . . | . . . | . . . | . . . | . . . | . . . | . . . | |
| 6 | . . . | 1 | 67 | facilityI.img | (141.40, 45.24) | (500, 10) | (10, 10) |
| . . . | . . . | . . . | . . . | . . . | . . . | | . . . |
| 37 | . . . | 312 | 23, 9, 156, . . . | integratedI.img | (139, 45, 35.41) | (440, 260) | (40, 40) |
| . . . | . . . | . . . | . . . | . . . | . . . | | . . . |

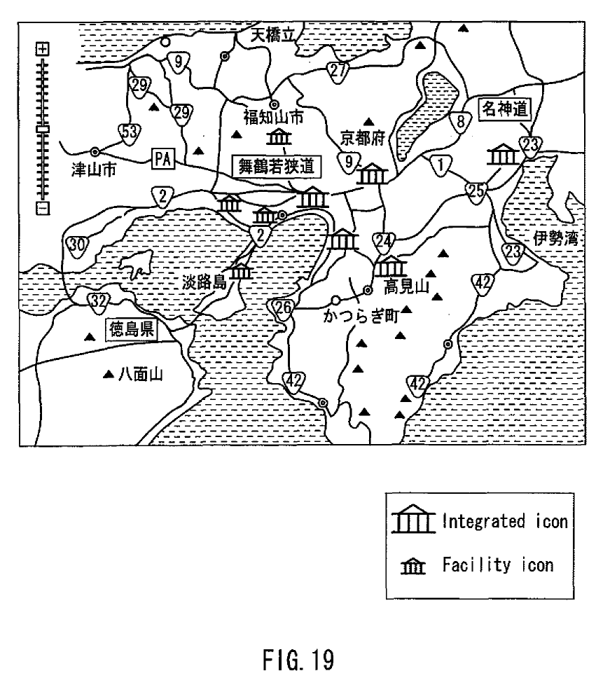

The display controlling part 15 refers the partition information table as Table 5 above, and allows the display 3 to display a map with the scale and the displaying range that are calculated in Op 43 with the displayed icon (Op 409). FIG. 19 is a view showing an example of a screen that is displayed by the display controlling part 15. In the processing shown in FIG. 14, since the displayed icon is displayed in each partition, the number of the icons is decreased, and a plurality for the icons are not overlapped with each other and do not hide the map, unlike the case of FIG. 5. Thus, the visibility of the map is improved.

### [Example of Information Detailing Processing]

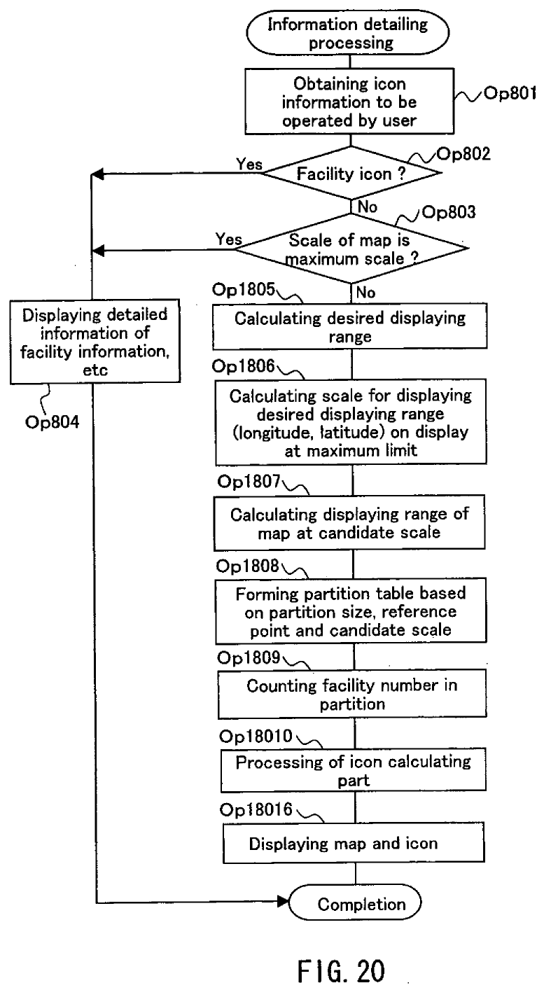

Next, in the flow chart shown in FIG. 2, an example of the information detailing processing in the case where the operation judging part 11 judges that the user performs the operation for demanding the information detailing processing (No in Op 7) will be described. FIG. 20 is a flow chart showing processing contents of the information detailing processing in Op 8 in FIG. 2.

In FIG. 20, Op 801 to 804 are the same as Op 801 to Op 804 in FIG. 9. Processing subsequent to Op 1805 will be described below. In Op 1805, the information detailing part 13a obtains a facility information ID of facility information included in a partition in which the integrated icon to be operated by the user is displayed from the partition information table of the icon attribution recording part 17a, further, refers to the POIDB of the map recording part 4, and obtains map positional coordinates (longitude, latitude) of the respective facilities. Then, the information detailing part 13a calculates a smallest quadrangle enclosing the map positional coordinates of these facilities, and defines this quadrangle as the desired displaying range. The information detailing part 13a transmits the above-described desired displaying range to the display controlling part 15, and allows the display controlling part 15 to calculate a candidate scale for displaying the desired displaying range (Op 1806). More specifically, the information detailing part 13a transmits, for example, a coordinate of a south-east corner (e0, n0) and a coordinate of a north-west corner (e1, n1) of the quadrangle that represents the desired displaying range to the displaying attribution calculating part 151, and can allow the displaying attribution calculating part 151 to calculate a scale and a displaying range on the map. Firstly, the displaying attribution calculating part 151 obtains the scale and the displaying range of the map that enable to display the quadrangle represented by the transmitted coordinates (e0, n0) and (e1, n1) in the displaying region of the display 3 at highest magnification. This calculation can be performed similarly to the calculation of the scale in Op 43 in FIG. 3 described above. The scale calculated here will be used as a candidate scale of the scale after the detailing.

Next, in Op 1807, the displaying attribution calculating part 151 calculates the displaying range of the map that is displayed at the candidate scale. The displaying attribution calculating part 151 can calculate this displaying range similarly to the calculation of the displaying range in Op 43 in FIG. 3 described above. That is, the displaying attribution calculating part 151 calculates a map positional coordinate ((e0+e1)/2, (n0+n1)/2) of a center of the quadrangle that represents the desired displaying range, and defines the quadrangle having this center as the displaying range.

When the candidate scale and the displaying range are calculated, the information detailing part 13a divides the map that is displayed with the candidate scale and the displaying range into a plurality of partitions, and allows the partition setting part 143 to execute processing for generating information on each partition and recording the information into the partition information table (Op 1808 to Op 1810). This processing can be performed similarly to those of Op 404 to 408 in FIG. 14. That is, when the information detailing part 13a transmits the candidate scale and the displaying range to the partition setting part 143, the partition setting part 143 generates the partition information table that records the map positional coordinate of each partition which is obtained by dividing the map displayed with the candidate scale and the displaying range (Op 1808). The POI information counting part 144 counts the number of facilities in each partition, and records the facility number with facility IDs into the partition information table (Op 1809), and the icon calculating part 142a calculates icon designs, icon sizes and displaying positions of the displayed icons that show the facilities in each partition, and records them into the partition information table (Op 1810). Thereby, the integrated icon designated by the user is detailed to be displayed with the new displaying range and scale.

In the example shown in FIG. 2, the case where the operation in which the user designates the icon continuously twice or more in a predetermined period of time is the operation showing the information detailing demand is described. In another example, an operation for designating a partition that corresponds to the icon, instead of designating the icon, can also be the information detailing operation with respect to the partition. Also in this case, by the processing similar to the processing of FIG. 20 described above, the designated partition can be detailed to be displayed.

### [Example of Information Integrating Processing]

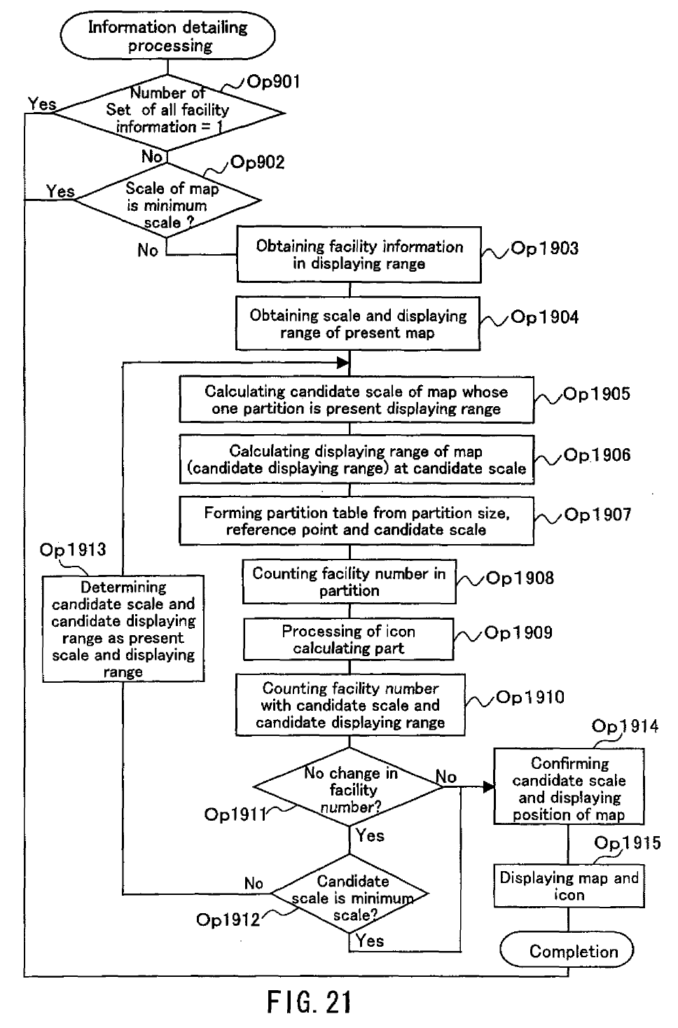

Next, in the flow chart shown in FIG. 2, an example of the information integrating processing of the present embodiment in the case where the operation judging part 11 judges that the user performs the operation for demanding information integrating processing (Yes in Op 7) will be described. FIG. 21 is a flow chart showing processing contents of the information integrating processing in Op 9 in FIG. 2.

In the case where a total facility information number is one in the whole map (Yes in Op 901), or in the case where the scale of the map is a minimum scale (Yes in Op 902), the information integrating part 12a completes the processing without performing the integrating processing.

In Op 1903, the information integrating part 12a obtains facility information in the displaying range (Op 1903). The information integrating part 12a obtains, for example, the facility information number and the like of the facilities represented by the icons that are displayed in the displaying range from the partition information table of the icon attribution recording part 17a. Moreover, the information integrating part 12a refers to the map DB of the map recording part 4 so as to obtain, for example, a map positional coordinate (longitude, latitude) converted to correspond to the pixel coordinate on the displaying screen that is designated by the user at the time of the integration demanding operation.

Next, the information integrating part 12a obtains a displaying range and a scale of a present map (Op 1904). Herein, the present map denotes a map that is displayed at the time of the operation by the user. The displaying range of the present map is represented by a map positional coordinate (longitude, latitude).

The information integrating part 12a calculates a candidate scale of the map after the integration such that the displaying range of the present map is displayed so as to have an area of about one partition of the map after the integration (Op 1906). The information integrating part 12a obtains the scale 1/N′ by using a formula (7) below, for example.

N′=(Dpw×M)/pw (7)

In the formula (7) above, 1/M that is a reciprocal of M is the scale before the integration (the present scale), pw is a pixel number that corresponds to a width of one partition, and Dpw is a pixel number that corresponds to a width of the displaying range of the display 3. The information integrating part 12a can also define a maximum scale (=1/N) which is equal to or smaller than 1/N′ among the scales that can be set by the car navigation apparatus as the candidate scale of the scale after the integration.

The information integrating part 12a calculates a displaying range (a candidate displaying range) of the map after the integration, which is displayed with the candidate scale (Op 1906). The information integrating part 12a can calculate the candidate displaying range based on, for example, the map positional coordinate (longitude, latitude) corresponding to the pixel coordinate of the position that is designated by the user at the time of the integration demanding operation, which is obtained in Op 1903, and the candidate scale. For example, the information integrating part 12a can define a region of a quadrangle whose center is at the map positional coordinate (longitude, latitude) corresponding to the pixel coordinate at the position that is designated by the user at the time of the integration demanding operation, which is a region having a size that can be displayed with the candidate scale, as the candidate displaying range.

When the candidate scale and the displaying range are calculated, the information integrating part 12a allows the partition setting part 143 to execute processing for dividing the map that is displayed with the candidate scale and the candidate displaying range into a plurality of partitions, generating information on each partition and recording the information into the partition information table (Op 1907 to Op 1909). This processing can be performed similarly to those of Op 404 to Op 408 in FIG. 14. That is, when the information integrating part 12a transmits the candidate scale and the displaying range to the partition setting part 143, the partition setting part 143 generates the partition information table in which map positional coordinates of the respective partitions that are obtained by dividing the map displayed with the candidate scale and the candidate displaying range are recorded (Op 1907). The POI information counting part 144 counts the number of facilities in each partition, and records it with facility IDs into the partition information table (Op 1908), and the icon calculating part 142a calculates icon designs, icon sizes and displaying positions of displayed icons showing the facilities in each partition, and records them into the partition information table (Op 1909).

Next, the information integrating part 12a refers the partition information table recorded in Op 1907 to Op 1909, and obtains the facility number of the facilities represented by one or more icons that are displayed with the candidate scale and the candidate displaying range (Op 1910). The information integrating part 12a compares the facility number obtained here with the facility number obtained in Op 1903 (Op 1911). Thereby the information integrating part 12a judges whether there is a change in facility number between the present display and the display with the candidate scale and the candidate displaying range or not. This aims to prevent the change in facility number, even when the scale and the displaying range are changed as a result of the integrating processing.

In the case where the facility number is not changed (Yes in Op 1911), and the candidate scale is not a minimum scale among scales that are set by the car navigation apparatus (No in Op 1813), the information integrating part 12a defines the candidate scale and the candidate displaying range as a present scale and a present displaying range (Op 1913), and repeats the processing of Op 1905 to Op 1909. Thereby, until when the facility number represented by the icons that are displayed in the candidate displaying range is changed, or the candidate scale reaches the minimum scale that can be set by the car navigation apparatus, the processing of Op 1905 to Op 1909 is repeated.

In the case of No in Op 1911, the information integrating part 12a records the candidate scale obtained in Op 1905 and the candidate displaying range obtained in Op 1906 as a new scale and a new displaying range into the map attribution recording part 16a (Op 1914). Then, the display controlling part 15 allows the display 3 to display the map and the icons based on the designs, the icon sizes and the displaying positions of the icons that are recorded in the partition information table of the icon attribution recording part 17a, and the new scale and the new displaying range that are recorded in the map attribution recording part 16a (Op 1915). Thereby, the icons that have been displayed previously are integrated to be displayed with the new displaying range and the new scale.

In the above-described example shown in FIGS. 20 and 21, the partition information table is formed every time when the user performs the operation, but it is also possible that the partition information table including all of the scales is recorded in advance, and the information detailing part 13a or the information integrating part 12a can refer to the partition information table at the time when the user performs the operation.

[Example of Case where POI Information is Word-of-Mouth Information]

In the above-described embodiment, the example of the case of picking up the facility information specifically among the POI information and displaying the facility icon was described, but the POI information is not limited to the facility information. For example, recently, there has been a service to record, into a server, word-of-mouth information on a certain point that is displayed on a map on the internet, and to share the word-of-mouth information between internet users. In this case, a location of this word-of-mouth information is displayed as an icon showing the word-of-mouth information (hereinafter, called a word-of-mouth icon) on the map. In the case of the word-of-mouth information, since information tends to be focused on the same point, the word-of-mouth icons may be displayed being overlapped in multiplicity, even at a time of displaying the map with the maximum scale.

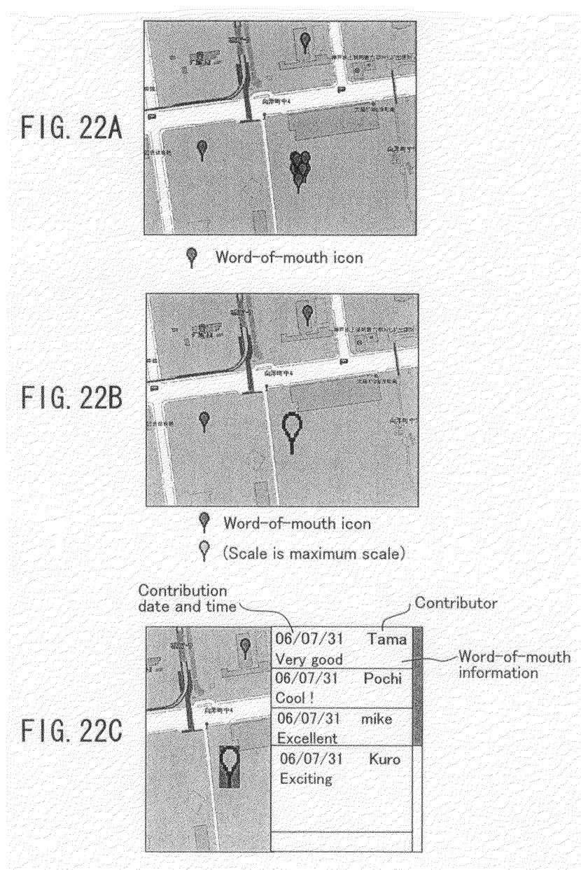

FIG. 22A is a view showing an example of the case where the word-of-mouth icons are displayed being overlapped in multiplicity at the time of displaying the map with the maximum scale. In this case, when displaying the map by using the information processing apparatus 10 of the present embodiment, the word-of-mouth icons are not displayed being overlapped, but are displayed as an integrated icon, as shown in FIG. 22B. In the case where the user performs the operation for the information detailing demand by designating an integrated icon that is displayed at the time of displaying at the maximum scale as shown in FIG. 22B, it is not possible to increase the scale further for detailing the integrated icon, because it is already displayed at the maximum scale.

In the present embodiment, such a case corresponds to the case of Yes in Op 803 in FIG. 20. That is, in the case where the scale of the map that is presently displayed on the display 3 is the maximum scale (Yes in Op 803), the information detailing part 13a allows the display controlling part 15 to display a detail of the word-of-mouth information represented by the integrated icon that is designated by the user. The detailed information of the word-of-mouth information is recorded in the POIDB of the map recording part 4, for example. The display controlling part 15 reads out the word-of-mouth information represented by the integrated icon that is designated by the user from the POIDB of the map recording part 4, and can allow the display 3 to display the word-of-mouth information. FIG. 22C is a view showing an example of the case of displaying the detail of the word-of-mouth information. In the example shown in FIG. 22C, a contribution date and time, a contributor and word-of-mouth information are displayed as the word-of-mouth information. In this case, the information detailing part 13a switches the screen, and instructs the display controlling part 15 to display the word-of-mouth detailed information in text form, instead of updating the displaying form data of the icon.

[Modified Example of Case where POI Information is Word-of-Mouth Information]

Moreover, as a modified example of the operation of the displayed icon data forming part 14a of the present embodiment, the icon calculating part 142a may calculate the icon designs, the icon sizes and the icon displaying positions of the word-of-mouth information even in the same partition so as to display them directly without integrating them, only in the case where the word-of-mouth icons can be displayed at the maximum scale without being overlapped.

In this case, the icon calculating part 142a judges whether the overlapping of the icons in the partition is present or absent only in the case of the maximum scale, and records it into the partition information table. For the judgment of the presence or absence of the overlapping of the icons in the partition, the method shown in Embodiment 1 can be used. Table 6 below is a table showing an example of data contents of the partition information table to which the data showing the presence or absence of the overlapping is added. Table 6 below includes the data showing the presence or absence of the overlapping in addition to the partition information table shown in Table 5 above. In the example shown in Table 6, “1” represents the presence of the overlapping, and ‘0’ represents the absence of the overlapping. And, in the case where there are a plurality of icons that are displayed without being overlapped in the same partition, entries in partition ID that is the same as the number of displayed icons are recorded In the example shown in Table 6 below, three entries in the partition ID of 10 are recorded. This suggests that two word-of-mouth icons that respectively represent two sets of word-of-mouth information (word-of-mouth information IDs=32, 67), and one integrated word-of-mouth icon that integrates two sets of word-of-mouth information (word-of-mouth information IDs=33, 41) are displayed in the partition in partition ID of 10.

TABLE 6

| | | | | | icon map | | | |
|---|---|---|---|---|---|---|---|---|
| | | number of | word-of- | | positional | | | |
| | map | sets of | mouth | | coordinate | | icon size | presence or |
| partition | positional | word-of-mouth | information | icon file | (longitude, | pixel | (width, | absence of |
| ID | coordinate | information | ID | name | latitude) | coordinate | height) | overlapping |
| 1 | . . . | 0 | (none) | (none) | (none) | (none) | (none) | 0 |
| . . . | . . . | . . . | . . . | . . . | . . . | . . . | | |
| 6 | . . . | 1 | 67 | word-of- | (141.40, 45.24) | (500, 10) | (10, 20) | 0 |
| | | | | mouth | | | | |
| | | | | I.img | | | | |
| . . . | . . . | . . . | . . . | . . . | . . . | | . . . | . . . |
| 10 | . . . | 1 | 32 | word-of- | ( . . . ) | (360, 59) | (10, 20) | 0 |
| | | | | mouth | | | | |
| | | | | I.img | | | | |
| 10 | . . . | 1 | 67 | word-of- | ( . . . ) | (375, 60) | (10, 20) | 0 |
| | | | | mouth | | | | |
| | | | | I.img | | | | |
| 10 | . . . | 2 | 33, 41 | integrated | ( . . . ) | (260, 40) | (12, 30) | 1 |
| | | | | KI.img | | | | |
| . . . | . . . | . . . | . . . | . . . | . . . | | . . . | . . . |
| 37 | . . . | 3 | 23, 9, 156 | integrated | (139.45, 35.41) | (440, 26) | (15, 40) | 1 |
| | | | | KI.img | | | | |
| . . . | . . . | . . . | . . . | . . . | . . . | | . . . | . . . |

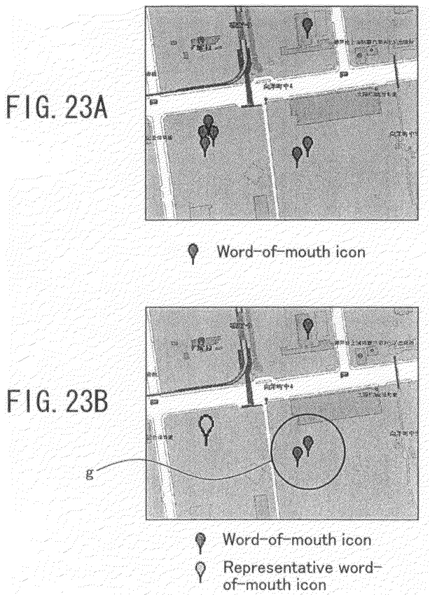

FIG. 23A is a view showing an example of a map (a map displayed at the maximum scale) in which word-of-mouth icons are displayed directly being overlapped without using the function of the information processing apparatus 10 of the present embodiment. FIG. 23B is a view showing an example of a map displayed by the operation shown in the present example that is performed by the information processing apparatus 10. In FIG. 23B, the word-of-mouth icons enclosed by a circle g are not overlapped, and thus are displayed without being integrated. Thereby, a condition where, even when the user wants to detail the integrated icon more, the integrated icon cannot be detailed to be displayed any more because it is displayed at the maximum scale can be avoided as much as possible.

In the present modified example, the icon calculating part 142a judges the presence or absence of the overlapping of the icon in each partition only in the case of the maximum scale, but it may always judge the presence or absence of the overlapping in each partition, without providing a condition particularly. Also, the icon calculating part 142a may judge the presence or absence of the overlapping in each partition, without being limited by the condition that is only in the case of the maximum scale in the above-described example, but in the case of satisfying other predetermined conditions.

As described above, by judging the presence or absence of the overlapping in each partition, the icons that are detailed to the extent that they are not overlapped in each partition can be displayed. Moreover, even in the case a large number of facility icons are overlapped and are spread out in a wide range over the partition, the icons that are displayed in each partition are determined based on the overlapping of the icons in each partition. Thereby, a problem in that information in a wide range is displayed by one integrated icon, and the display does not accord with a human sense can be prevented.

[Another Modified Example of Case where POI Information is Word-of-Mouth Information]

In the above-described embodiment, the icon calculating part 142a determines the design of the icon based on the number of facilities in the partition that are counted in Op 405. The method for determining the design of the icon is not limited to this. The icon calculating part 142a can determine the icon design based on the attribution of the POI information shown by the icon. For example, in the case where the POI information is data registered by a plurality of users, such as word-of-mouth information, the icons whose icon designs are varied according to the registered users can be displayed.

Table 7 below is an example of data contents of a word-of-mouth information table for recording the word-of-mouth information as an example of the POI information. The word-of-mouth information table is included in the POIDB, for example In Table 7, word-of-mouth information IDs, map positional coordinates showing positions of the word-of-mouth information, registered user IDs showing the user who registered the word-of-mouth information, registered dates and times, reputations and word-of-mouth information are recorded. The reputation is information that shows a reputation of the word-of-mouth information (for example, good, poor or fair).

TABLE 7

| | map | | | | |
|---|---|---|---|---|---|
| word-of- | positional | | | | |
| mouth | coordinate | regis- | registered | | |
| infor- | (longitude, | tered | date and | | word-of-mouth |
| mation ID | latitude) | user | time | reputation | information |
| 1 | (***, ***) | 1 | Jul. 31, 2006 | good | very good |
| 2 | (***, ***) | 5 | Jul. 31, 2006 | good | excellent |
| 3 | (***, ***) | 7 | Jul. 31, 2006 | poor | not so good |
| 4 | (***, ***) | 27 | Jul. 31, 2006 | good | exciting |
| . . . | . . . | . . . | . . . | | . . . |

For example, the image data of the icon design for each user who registered the word-of-mouth information is recorded into the icon attribution recording part 17a as a user icon information table in advance, and when determining an icon design for certain word-of-mouth information, the icon calculating part 142a refers to the word-of-mouth information table of the POIDB so as to obtain the registered user ID who registered the word-of-mouth information, and can determine the image data of the icon design that corresponds to the user having the registered user ID based on the user icon information table. The user registers the word-of-mouth information by, for example, recording the word-of-mouth information into the word-of-mouth information table of the POIDB via a network.

Table 8 below is a table showing an example of data contents of the user icon information table in which information showing the image data of the icon design for each user is recorded. In Table 8 below, a user ID, a user name and an icon file name are recorded for each user. The icon file name is a file name of the image data of the icon design that corresponds to the user represented by the user ID.

TABLE 8

| userID | user name | icon file name |
|---|---|---|
| 1 | Tama | Tama.img |
| . . . | . . . | . . . |
| 5 | Mike | Mike.img |
| . . . | . . . | . . . |
| 27 | Kuro | Kuro.img |
| . . . | . . . | . . . |

Moreover, when determining an icon design of an integrated icon that shows a plurality of sets of word-of-mouth information by integration, the icon calculating part 142a can obtain, from the word-of-mouth information table, a user ID of a user who registered the largest number of sets of word-of-mouth information among users who registered a plurality of sets of the word-of-mouth information, and can determine the icon design that corresponds to the user ID by referring the user icon information table.

For example, when the icon calculating part 142a determines icon designs of icons that are displayed in one partition, in the case where one set of word-of-mouth information is included in the partition, the icon calculating part 142 obtains an icon file name of image data of an icon design that corresponds to a user ID who registered the word-of-mouth information from the user icon information table. Moreover, in the case where a plurality of sets of word-of-mouth information are included in the partition, the icon calculating part 142a obtains the icon file name of the image data of an icon design that corresponds to the user ID who registered the largest number of the sets of the word-of-mouth information among the users who registered the plurality of the sets of the word-of-mouth information from the user icon information table. The icon calculating part 142a defines the image data shown by the obtained icon file name as image data of the integrated icon to be displayed. Moreover, the icon calculating part 142a can calculate a size of the integrated icon according to the number of the sets of the word-of-mouth information that are registered by the user.

Also, when determining the icon design of the integrated icon that integrates icons which can be displayed being overlapped, similarly to the case in Embodiment 1, the icon calculating part 142 can also determine the icon design by the user who registered the word-of-mouth information similarly. For example, in the case where the icon showing the word-of-mouth information is not overlapped with other icon, the icon calculating part 142 assigns the icon design that corresponds to the user who registered the word-of-mouth information to the icon. In the case where the icon showing the word-of-mouth information is overlapped with other icon, the icon calculating part 142 can define the icon design that corresponds to the user who registered the largest number of the sets of the word-of-mouth information, among the word-of-mouth information of the overlapping icons, to an icon design for the integrated icon.

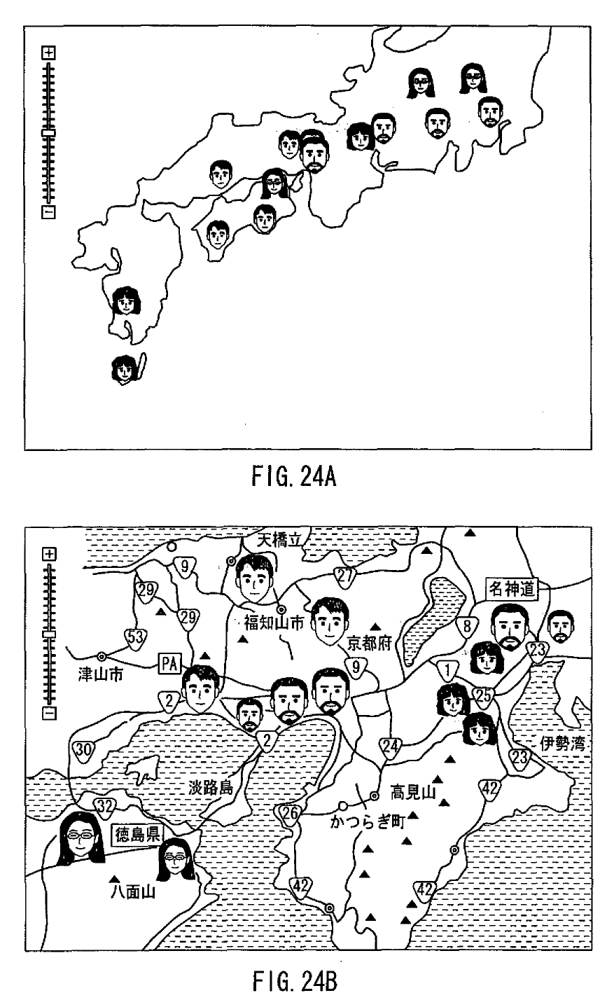

FIGS. 24A and 24B are views showing an example of a case where the icon designs are varied to be displayed according to the users who registered the word-of-mouth information. A map shown in FIG. 24A is an example of a map obtained by integrating a map shown in FIG. 24B, and the map shown in FIG. 24B is an example of the map obtained by detailing the map shown in FIG. 24A. In the example shown in FIGS. 24A and 24B, a location of the word-of-mouth information is displayed on the map by an icon representing a face of the user who registered it. Moreover, the size of the icon is varied to be displayed according to the number of the sets of the word-of-mouth information. Thus, by watching the display, the user can recognize, at one glance, a user who registered the largest number of sets of word-of-mouth information at, for example, the point where a large number of sets of the word-of-mouth information are present densely.

Moreover, another example for varying a displaying form of an icon according to the attribution of the POI information will be described. For example, in the case of displaying an icon showing a location of word-of-mouth information, an icon design can be varied to be displayed according to a reputation of the word-of-mouth information. For example, as shown in Table 7 above, data showing a reputation (for example, good, poor, fair or the like) is recorded for each set of the word-of-mouth information into the word-of-mouth information table, and the icon calculating part 142a may determine a design of the icon based on the data showing the reputation of the word-of-mouth information. Incidentally, the data showing the reputation of the word-of-mouth information can be generated automatically, by analyzing text data showing the word-of-mouth information. For this generation of the word-of-mouth information, known techniques for analyzing a meaning of the text data can be used. Moreover, for example, the icon attribution recording part 17a records reputational icon information showing the image data of the icon design that corresponds to each reputation such as good, poor and fair in advance, and the icon calculating part 142a can refer to the reputational icon information at the time of determining the icon design.

For example, when determining an icon design of an icon that represents word-of-mouth information in one partition, in the case where one set of the word-of-mouth information is included in the partition, the icon calculating part 142a obtains a reputation of the word-of-mouth information (for example, information represented by text data) from the word-of-mouth information table. The icon calculating part 142a determines the icon design based on the obtained reputation (for example, good, poor or fair). In the case where a plurality of sets of word-of-mouth information are included in the partition, it is also possible that the icon calculating part 142a obtains the reputations (for example, good, poor or fair) of respective set of the word-of-mouth information, counts the number of the respective reputations (good, poor or fair), and determines the icon design of the integrated icon based on a majority of the reputations.

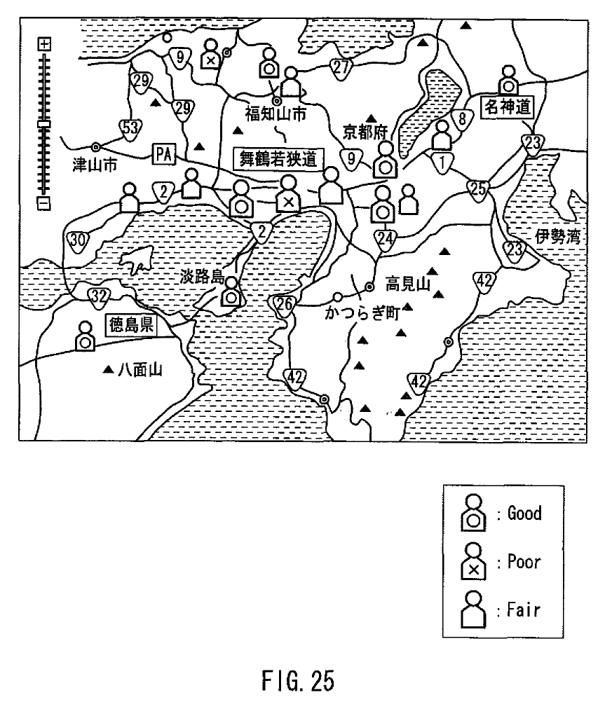

FIG. 25 is a view showing an example for varying to display the icon designs according to the reputations (good, poor or fair) of the word-of-mouth information. By displaying as FIG. 25, the user can recognize a place with a good reputation and a place with a poor reputation at one glance.

As described above, as the attribution of the POI information, the reputation of the word-of-mouth information and the registered user are exemplified for the explanation, but the attribution of the POI information is not limited to the above-described example. For example, a sex, age or the like of the user may also be the attribution of the POI information. Also, for example, the icon calculating part 142a may extract a key word from the text information of the word-of-mouth information that is recorded as the POI information, and determine the icon design according to the key word that appears most frequently.

The present invention is useful as the information processing apparatus that can secure the visibility of the map, and can enhance the easiness of the operations for obtaining the point information such as the facility information, the traffic information and the reputational information on the map.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information processing apparatus that is connected to a map recording part in which map information and point information on a predetermined point shown by the map information is recorded, a display and an input apparatus,
the information processing apparatus comprising:
a display controlling part that allows the display to display: a map; and a point mark including at least one of an integrated point mark that integrates point information of a plurality of points and is represented by one mark and a single point mark that represents point information of one point, based on the map information and the point information that are recorded in the map recording part;
an information detailing part that, in a case where an operation by a user for demanding information detailing of the integrated point mark that is displayed on the display is detected via the input apparatus, generates displaying form data of a plurality of the point marks that represent point information of the plurality of the points integrated by the integrated point mark, calculates a scale and a displaying range that enable to display the plurality of the point marks, and allows the display to display the plurality of the point marks represented by the displaying form data and the map with the scale and the displaying range; and
an information integrating part that, in a case where an operation by the user for demanding information integration of the point marks that are displayed on the display is detected via the input apparatus, generates displaying form data of the integrated point mark that represents by integrating point information of a plurality of points including points of the point marks, calculates a scale and a displaying range that enable to display the integrated point mark in a wider range than a range at the time of the operation by the user, and allows the display to display the integrated point mark represented by the displaying form data and the map with the scale and the displaying range.

2. The information processing apparatus according to claim 1, wherein the information detailing part calculates the scale and the displaying range that enables to display, in one screen, all of the plurality of the point marks that represent a plurality of sets of the point information integrated by the integrated point mark.

3. The information processing apparatus according to claim 1, wherein the information integrating part calculates the scale and the displaying range such that the integrated point mark represented by the displaying form data is displayed at the same position as a position where the point mark that is demanded for the integration by the user is displayed at the time of the operation by the user.

4. The information processing apparatus according to claim 1, wherein
the information detailing part calculates the scale and the displaying range to an extent that the plurality of the point marks representing the plurality of the sets of the point information that are integrated by the integrated point mark can be displayed without being overlapped with one another, and
the information integrating part calculates the scale and the displaying range to an extent that the point marks which respectively represent the point information of the plurality of the points in a predetermined range from a point corresponding to the point mark are displayed being overlapped with each other.

5. The information processing apparatus according to claim 1 further comprising:
a partition setting part that generates partition information on each partition in a case of dividing the map that is displayed with the scale and the displaying range into a plurality of partitions, based on the scale and the displaying range of the map recorded in a map attribution recording part; and
a mark calculating part that obtains the point information in the partition, each of which is represented by the partition information generated by the partition setting part, from the map recording part, and generates the displaying form data of the point mark displayed in the partition based on the position information, wherein
the information detailing part calculates the scale and the displaying range based on the point information included in the partition, in which the integrated point mark is present, among the partitions of the map that are displayed at the time of the operation by the user, allows the partition setting part to generate partition information related to each partition that is obtained by dividing the map displayed with the calculated scale and displaying range, and allows the mark calculating part to generate displaying form data of the point mark that is displayed in each partition represented by the partition information, and
the information integrating part calculates a scale and a displaying range of a map after the integration such that the displaying range displayed at the time of the operation by the user corresponds to at least one partition in the map after the integration, allows the partition setting part to generate partition information on each partition that is obtained by dividing the map which is displayed with the calculated scale and displaying range, and allows the mark calculating part to generate displaying form data of the point mark that is displayed in each partition represented by the partition information.

6. The information processing apparatus according to claim 1, wherein the information integrating part determines a size of an integrated point mark that representatively shows point information of a plurality of points that are present in a predetermined range from a point corresponding to the designated point mark, according to the number of the plurality of the points that are present in the predetermined range, and allows the displaying form data to include the size of the integrated point mark as a part.

7. A recording medium storing an information processing program that allows a computer to execute processing, the computer being connected to a map recording part in which map information and point information on a predetermined point shown by the map information are recorded, a display and an input apparatus,
the recording medium storing the information processing program that allows the computer to execute:
display controlling processing of allowing the display to display: a map; and a point mark including at least one of an integrated point mark that integrates point information of a plurality of points and is represented by one mark, and a single point mark that represents point information of one point, based on the map information and the point information that are recorded in the map recording part;
information detailing processing comprising, in a case where an operation by a user for demanding information detailing of the integrated point mark that is displayed on the display is detected via the input apparatus, generating displaying form data of a plurality of the point marks that represent point information of a plurality of points integrated by the integrated point mark, calculating a scale and a displaying range that enable to display the plurality of the point marks, and allowing the display to display the plurality of the point marks represented by the displaying form data and the map with the scale and the displaying range; and
information integrating processing comprising, in a case where an operation by the user for demanding information integration of the point marks that are displayed on the display is detected via the input apparatus, generating displaying form data of the integrated point mark that represents by integrating point information of a plurality of points that are present in a predetermined range from the point that corresponds to the point mark, calculating a scale and a displaying range that enable to display the integrated point mark in a wider range than a range at the time of the operation by the user, and allowing the display to display the integrated point mark represented by the displaying form data and the map with the scale and the displaying range.

8. An information processing method executed by a computer that is connected to a map recording part in which map information and point information on a predetermined point shown by the map information are recorded, a display and an input apparatus,
the information processing method comprising:
a display controlling step allowing the display to display: a map; and a point mark including at least one of an integrated point mark that integrates point information of a plurality of points and is represented by one mark, and a single point mark that represents point information of one point, based on the map information and the point information that are recorded in the map recording part;
an information detailing step comprising, in a case where an operation by a user for demanding information detailing of the integrated point mark that is displayed on the display is detected via the input apparatus, generating displaying form data of a plurality of the point marks that represent point information of a plurality of points integrated by the integrated point mark, calculating a scale and a displaying range that enable to display the plurality of the point marks, and allowing the display to display the plurality of the point marks represented by the displaying form data and the map with the scale and the displaying range; and
an information integrating step comprising, in a case where an operation by the user for demanding information integration of the point marks that are displayed on the display is detected via the input apparatus, generating displaying form data of the integrated point mark that represents by integrating point information of a plurality of points that are present in a predetermined range from the point that corresponds to the point mark, calculating a scale and a displaying range that enable to display the integrated point mark in a wider range than a range at the time of the operation by the user, and allowing the display to display the integrated point mark represented by the displaying form data and the map with the scale and the displaying range.
